(19) United States
(12) Patent Application Publication
(10) Pub. No.: US 2008/0081167 A1
(43) Pub. Date: Apr. 3, 2008

(54) CELLULOSE RESIN FILM AND METHOD FOR PRODUCING THE SAME

(75) Inventor: Tadashi Ueda, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/864,653

(22) Filed: Sep. 28, 2007

(30) Foreign Application Priority Data
Sep. 28, 2006 (JP) 2006-265492

(51) Int. Cl. C08J 5/18; B29C 47/00

(52) U.S. Cl. 428/221; 264/177.11

(57) ABSTRACT

In general, the step-like unevenness due to the fluctuation in the sheet-shaped molten resin in the vicinity of the surface of the cooling support remains as it is as thickness unevenness without undergoing leveling because the sheet-shaped molten resin is cast on the cooling support immediately after generation of the fluctuation to be solidified by cooling. However, according to an aspect of the present invention, the vibration of the sheet-shaped molten resin in the vicinity of the surface of the cooling support is specified to be 10 dB or less, and accordingly, the fluctuation of the sheet-shaped molten resin in the vicinity of the surface of the cooling support is suppressed and the sheet-shaped molten resin sufficiently undergoes leveling on the cooling support. Consequently, the generation of the continuous and periodic step-like thickness unevenness along the lengthwise direction of the sheet-shaped molten resin can be prevented.

### BACKGROUND OF THE INVENTION

1. Field of the Invention

The present invention relates to a cellulose resin film and a method for producing the same, in particular, a cellulose resin film for use in optical applications and a method for producing the same.

2. Description of the Related Art

A cellulose resin film is obtained by a method comprising the steps of melting a cellulose resin in an extruder, discharging the molten resin thus obtained from a die in a form of a sheet onto a cooling drum to be cooled thereon, and stripping the cellulose resin film thus formed from the drum (for example, see Japanese Patent Application Laid-Open No. 2000-352620). For practical purposes, such a cellulose resin film has hitherto been stretched along the longitudinal (lengthwise) direction and along the transverse (widthwise) direction of the film to develop the in-plane retardation (Re) and the thicknesswise retardation (Rth) to be used as a retardation film in a liquid crystal display element for the purpose of widening viewing angle.

### SUMMARY OF THE INVENTION

However, such a cellulose resin film produced in Japanese Patent Application Laid-Open No. 2000-352620 suffers from a problem such that the mechanical vibration of the die to discharge the molten resin, the rotational vibration due to the eccentricity of the cooling drum, and the air pressure vibration due to the air flow between the die and the cooling drum are transmitted to the sheet-shaped molten resin discharged from the die, so that the film obtained by cooling the sheet-shaped molten resin on the cooling drum undergoes generation of thickness unevenness, in particular, generation of a continuous and periodic step-like thickness unevenness along the lengthwise direction of the film so as to inhibit formation of a film with excellent surface conditions.

When such a film, for example, is used as a film for use in a liquid crystal device, sometimes display unevenness has been caused. Thus, conventional cellulose resin films can hardly be said to sufficiently have proper qualities required for films for use in liquid crystal devices.

The present invention has been achieved in view of the above described circumstances, and takes as its objects the provision of a cellulose resin film small in thickness unevenness and a method for producing the same on the basis of a melt film formation method.

A first aspect of the present invention provides, for the purpose of achieving the above-mentioned objects, a method for producing a cellulose resin film based on a melt film formation method comprising the steps of: discharging a molten resin melted with an extruder from a discharge opening of a die as a sheet-shaped molten resin onto a traveling or rotating cooling support to be solidified by cooling; thereafter stripping off the sheet as a cellulose resin film; and winding up the cellulose resin film on a wind-up spool; wherein the fluctuation of the sheet-shaped molten resin in the vicinity of the surface of the cooling support is 10 dB or less.

In general, the step-like unevenness due to the fluctuation in the sheet-shaped molten resin in the vicinity of the surface of the cooling support remains as it is as thickness unevenness without undergoing leveling because the sheet-shaped molten resin is cast on the cooling support immediately after generation of the fluctuation to be solidified by cooling. However, according to the first aspect, the vibration of the sheet-shaped molten resin in the vicinity of the surface of the cooling support is specified to be 10 dB or less, and accordingly, the fluctuation of the sheet-shaped molten resin in the vicinity of the surface of the cooling support is suppressed and the sheet-shaped molten resin sufficiently undergoes leveling on the cooling support. Consequently, the generation of the continuous and periodic step-like thickness unevenness along the lengthwise direction of the sheet-shaped molten resin can be prevented.

A second aspect of the present invention is characterized in that the length of the sheet-shaped molten resin between the discharge opening of the die and the landing position on the cooling support is 10 mm to 100 mm.

The second aspect specifies a preferable range of the length of the sheet-shaped molten resin between the discharge opening of the die and the landing position on the cooling support. Specifically, according to the second aspect, the length of the sheet-shaped molten resin between the discharge opening of the die and the landing position on the cooling support is specified to be 10 mm to 100 mm, accordingly the sheet-shaped molten resin hardly fluctuated by the air pressure vibration or the mechanical vibration, and consequently the fluctuation of the sheet-shaped molten resin in the vicinity of the surface of the cooling support can be made to be 10 dB or less.

A third aspect of the present invention specifies a preferable range of the fluctuation of the die. Specifically, by specifying the die fluctuation to be 30 dB or less, the fluctuation of the sheet-shaped molten resin in the vicinity of the surface of the cooling support can be made to be 10 dB or less. Consequently, a sheet-shaped molten resin free from thickness unevenness can be obtained.

A fourth aspect of the present invention, according to any one of the first to third aspects, is characterized in that the surface temperature of the cooling support is Tg−20° C. to Tg+20° C., wherein Tg means the glass transition temperature of the molten resin.

The fourth aspect specifies a preferable temperature range of the surface temperature of the cooling support. Specifically, by specifying the surface temperature of the cooling support to be Tg−20° C. to Tg+20° C., the sheet-shaped molten resin having landed without fluctuation is cooled while sufficiently undergoing leveling. Consequently, the generation of the continuous and periodic step-like thickness unevenness along the lengthwise direction of the sheet-shaped molten resin can be prevented.

A fifth aspect of the present invention, according to any one of the first to fourth aspects, is characterized in that the surface roughness of the surface of the cooling support is 0.5 μm or less.

The fifth aspect specifies a preferable range of the surface roughness of the surface of the cooling support. Specifically, by specifying the surface roughness of the surface of the cooling support to be 0.5 μm or less, the surface of the cooling support is a mirror surface or is in a state of being close to a mirror surface. Consequently, a cellulose resin film excellent in surface conditions suitable for optical applications or the like can be provided.

A sixth aspect of the present invention, according to any one of the first to fifth aspects, is characterized in that the surface of the cooling support is plated with hard chrome.

The sixth aspect specifies a preferable material for surface treatment of the surface of the cooling support. Specifically, by plating the surface of the cooling support with hard chrome, the durability of the surface of the cooling support can be improved, and generation of flaws on the sheet-shaped molten resin due to the flaws generated on the surface of the cooling support can be prevented. Consequently, a cellulose resin film excellent in surface conditions and suitable for optical applications or the like can be provided.

A seventh aspect of the present invention, according to any one of the first to sixth aspects, is characterized in that the method for producing a cellulose resin film further comprises a step of blowing air to the molten resin discharged from the die, from an air knife unit disposed between the die and the cooling support.

According to the seventh aspect, air is blown to the sheet-shaped molten resin from the air knife unit and hence the sheet-shaped molten resin is pushed against the surface of the cooling support to be prevented from fluctuation caused by external disturbance due to the air pressure vibration or the mechanical vibration, and consequently, the fluctuation of the sheet-shaped molten resin in the vicinity of the surface of the cooling support can be made to be 10 dB or less.

An eighth aspect of the present invention, according to any one of the first to sixth aspects, is characterized in that the method for producing a cellulose resin film further comprises a step of applying static electricity to the sheet-shaped molten resin discharged from the die with a static electricity application unit disposed between the die and the cooling support.

According to the eighth aspect, the molten resin discharged from the die is imparted with static electricity by using the static electricity application unit, and hence the sheet-shaped molten resin is made to adhere to the surface of the cooling support so as to be prevented from the fluctuation caused by the external disturbance due to the air pressure vibration or the mechanical vibration, so that the fluctuation of the sheet-shaped molten resin in the vicinity of the surface of the cooling support can be made to be 10 dB or less.

A ninth aspect of the present invention, according to any one of the first to sixth aspects, is characterized in that the method for producing a cellulose resin film further comprises a step of applying a reduced pressure to a side, upstream of the rotation or traveling direction of the cooling support, of the sheet-shaped molten resin discharged from the die with a pressure reduction chamber.

According to the ninth aspect, the atmosphere of the sheet-shaped molten resin in the vicinity of the cooling support is reduced in pressure by using the pressure reduction chamber, and hence the sheet-shaped molten resin is pushed against the surface of the cooling support, so as to be prevented from the fluctuation caused by the external disturbance due to the air pressure vibration or the mechanical vibration, so that the fluctuation of the sheet-shaped molten resin in the vicinity of the surface of the cooling support can be made to be 10 dB or less.

A tenth aspect of the present invention, according to any one of the first to sixth aspects, is characterized in that the method for producing a cellulose resin film further comprises a step of edge-pinning both of the edges of the sheet-shaped molten resin discharged from the die by applying charge from edge pinning electrodes to both of the edges.

According to the tenth aspect, both of the edges of the sheet-shaped molten resin are subjected to edge pinning by applying charge from the edge pinning electrodes to both of the edges, the adhesion of the sheet-shaped molten resin to the cooling support is thereby improved, and hence the distortion (neck in) of the sheet-shaped molten resin occurring between the die and the landing position on the cooling support can be stabilized, so that the fluctuation of the sheet-shaped molten resin in the vicinity of the surface of the cooling support can be made to be 10 dB or less.

An eleventh aspect of the present invention, according to any one of the first to tenth aspects, is characterized in that the method for producing a cellulose resin film further comprises a step of imparting a knurling of 5 mm to 20 mm in width and 5 μm to 30 μm in height to each of the both edges of the cellulose resin film in advance of the winding-up step.

The eleventh aspect specifies the conditions for satisfactorily winding up the cellulose resin film free from thickness unevenness produced according to any one of the first to tenth aspects; by applying a knurling treatment as described above to both of the edges of the cellulose resin film in advance of the winding-up step, generation of the displacement failure of the winding-up roll can be prevented.

A twelfth aspect of the present invention, according to the eleventh aspect, is characterized in that the method for producing a cellulose resin film further comprises a step of heating the knurling-imparted portions of the cellulose resin film at Tg+10° C. to Tg+50° C.

The twelfth aspect specifies a preferable temperature range in heating the knurling-imparted portions. Specifically, by heating the knurling-imparted portions at Tg+10° C. to Tg+50° C., the settling of the knurlings can be suppressed. Consequently, the film can be wound up by using a winding-up roll with an optimal tension.

A thirteenth aspect of the present invention, according to any one of the first to twelfth aspects, is characterized in that the thickness unevenness per 1 m along the lengthwise direction in the cellulose resin film is within ±2% and the thickness unevenness per the total width along the widthwise direction in the cellulose resin film is within ±2%.

The thirteenth aspect is a method suitable for producing a cellulose resin film strict as described above in the order of magnitude of errors in the thickness unevenness.

A fourteenth aspect of the present invention is a method for producing a cellulose resin film according to any one of the first to thirteenth aspects, wherein the cellulose resin film is a film for use in optical applications.

The fourteenth aspect is a method suitable for producing a cellulose resin film strict, as for films for use in optical applications, in the order of magnitude of errors in the thickness unevenness.

A fifteenth aspect of the present invention provides a cellulose resin film for use in optical applications produced by the method for producing a cellulose resin film according to any one of the first to fourteenth aspects.

This is because a cellulose resin films free from thickness unevenness are particularly suitable for use in optical applications including liquid crystal display devices.

According to the present invention, a cellulose resin film can be produced without creating a defect of thickness unevenness, and hence an optical film excellent in optical properties can be obtained.

### BRIEF DESCRIPTION OF THE DRAWINGS

FIG. 1 is a diagram illustrating a configuration of a film production apparatus to which the present invention is applied;

FIG. 2 is a schematic view illustrating a configuration of an extruder;

FIG. 3 is a schematic view illustrating a sheet-shaped molten resin discharged from a die;

FIG. 4 is a schematic view illustrating an example in which an air knife is disposed between the die and a cooling drum;

FIG. 5 is a schematic view illustrating an example in which a back chamber is disposed between the die and the cooling drum;

FIG. 6 is a schematic view illustrating an example in which a static electricity application unit is disposed between the die and the cooling drum;

FIG. 7 is a schematic view illustrating an example in which an edge pinning unit is disposed between the die and the cooling drum;

FIG. 8 is a table describing Examples of the present invention; and

FIGS. 9A and 9B are tables describing Examples of the present invention.

### DETAILED DESCRIPTION OF THE PREFERRED EMBODIMENTS

Hereinafter, preferred embodiments of the cellulose resin film and the method for producing the same according to the present invention will be described with reference to the accompanying drawings. It is to be noted that although an example of the production of a cellulose acylate film on the basis of a melt film formation method is described in the present embodiments, the present invention is not limited to the present embodiments.

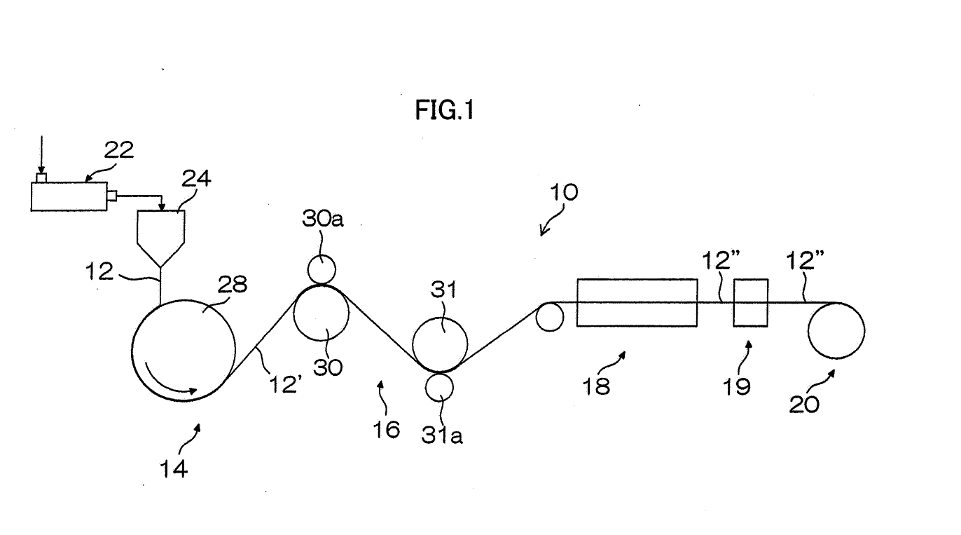

FIG. 1 shows an example of a schematic configuration of a production apparatus of a cellulose acylate film, and the apparatus will be described on a case where a cellulose acylate film is produced by means of a melt film formation method.

As shown in FIG. 1, a production apparatus 10 is mainly constituted with a film formation section 14 for forming a not-yet stretched cellulose acylate film 12, a longitudinal stretching section 16 and a transverse stretching section 18 for longitudinally and transversely stretching the not-yet stretched cellulose acylate film 12 produced in the film formation section 14, respectively, a knurling treatment section 19 for imparting knurlings to a stretched cellulose acylate film 12″, and a winding-up section 20 for winding up the cellulose acylate film 12′″ subjected to the knurling treatment.

In the film formation section 14, a molten cellulose acylate resin obtained by melting in an extruder 22 is discharged from a die 24 as a sheet-shaped molten resin 12, and cast onto a rotary cooling drum 28 (cooling support) to be rapidly cooled and solidified. Thus, a cellulose acylate film 12 is formed.

The cooling drum 28 is a rotary cooling drum having a structure allowing a cooling medium (e.g. water) to be circulated in the inside of the cooling drum 28. The surface temperature of the cooling drum 28 is preferably Tg−20° C. to Tg+20° C. The reason for this is such that: when the surface temperature is lower than Tg−20° C., the sheet-shaped molten resin 12 becomes difficult to adhere to the cooling drum 28, and hence the thickness accuracy of the sheet-shaped molten resin 12 is degraded to generate thickness unevenness; on the other hand, when the surface temperature exceeds Tg+20° C., the adhesion between the sheet-shaped molten resin 12 and the cooling drum 28 becomes too strong, the sheet-shaped molten resin 12 comes to be stretched, and consequently an orientational distortion is created in a cellulose acylate film 12′.

Additionally, the surface of the cooling drum 28 preferably has a surface roughness of 0.5 μm or less. The reason for this is such that when the surface roughness exceeds 0.5 μm, the sheet-shaped molten resin 12 cast on the cooling drum 28 suffers from flaws formed on the sheet-shaped molten resin due to the cellulose acylate resin adhering to the surface of the cooling drum 28.

Further, the surface of the cooling drum 28 is preferably plated with hard chrome. The reason for this is such that the hard chrome plating is excellent in durability and can suppress the generation of flaws on the surface of the cooling drum 28.

A cooling band may also be used in place of the cooling drum 28, although such a band is not shown. Such a cooling band is wound around a driving roller and a driven roller, and is made to travel by driving the driving roller while orbiting elliptically.

Thereafter, the thus formed cellulose acylate film 12′ is striped off from the cooling drum 28, and successively transferred to the longitudinal stretching section 16 and the transverse stretching section 18. Here, the longitudinal stretching section 16 is provided with low-speed roller 30, 30a, and high-speed roller 31, 31a, and the cellulose acylate film 12′ is longitudinally stretched due to the circumferential velocity difference between these two rollers. After the stretching in the longitudinal stretching section 16 and the transverse stretching section 18, the cellulose acylate film 12″ is subjected to a knurling treatment in the knurling treatment section 19. In the knurling treatment section 19, each of the both edges of the cellulose acylate film 12″ is imparted with a knurling having a fine pattern of protrusions and recesses formed by embossing, and then the cellulose acylate film 12″ is wound up in a form of roll in the winding-up section 20. In this way, by imparting such knurlings to the cellulose acylate film before the cellulose acylate film 12′″ is wound up in the winding-up section 20, no needless force due to the slipping or the like between the film and the winding-up roller is made to exert on the cellulose acylate film 12′″ when wound up. Consequently, the stretched cellulose acylate film 12′″ free from thickness unevenness and excellent in optical properties is produced.

The knurlings are preferably formed on the both edges of the cellulose acylate film 12′″ so as each to be 5 mm to 20 mm in width and 5 μm to 30 μm in height. The reason for this is such that: when width of the area in which each of the knurlings is formed is less than 5 mm, no sufficient tension can be obtained at the time of winding up the cellulose acylate film 12′″ by using a winding-up roll; on the other hand, when the width exceeds 20 mm, excessive tension is exerted on the film at the time of winding up the cellulose acylate film 12′″ by using a winding-up roll, and hence flaws caused by the contact with the winding-up roll adhere to the film; additionally, when the height of each of the knurlings is less than 5 μm, no sufficient tension can be obtained at the time of winding up the cellulose acylate film 12′″ by using a winding-up roll; and on the other hand, when the height of each of the knurlings exceeds 30 μm, excessive tension is exerted on the film at the time of winding up the cellulose acylate film 12′″ by using a winding-up roll, and hence flaws caused by the contact with the winding-up roll adhere to the film.

The knurling-imparted portions of the cellulose resin film are preferably heated in a temperature range from Tg+10° C. to Tg+50° C. from the viewpoint of preventing the settling of the knurlings. Here, Tg (glass transition temperature) means the temperature at which a glass transition occurs in a polymer material.

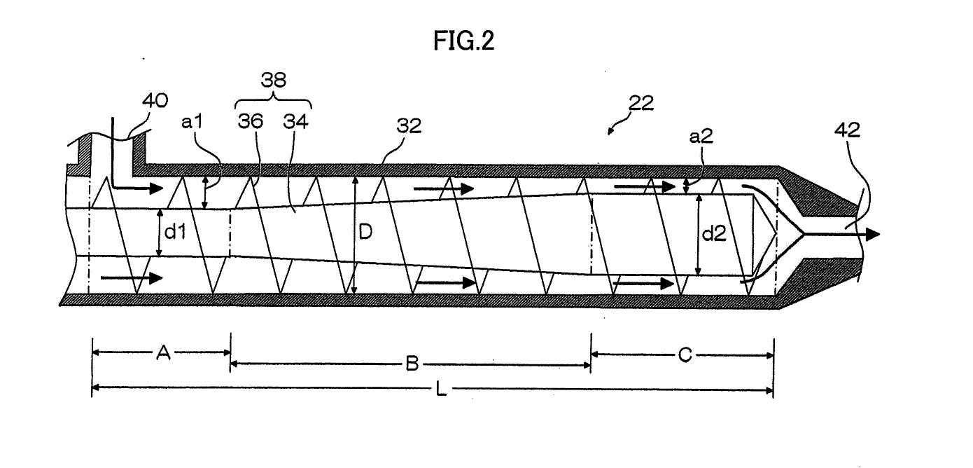

FIG. 2 is a sectional view illustrating a single screw extruder 22.

As shown in FIG. 2, a single screw 38 having a flight 36 on the screw shaft 34 is disposed in a cylinder 32, and a cellulose acylate resin is fed from a not shown hopper through a feed opening 40 into the cylinder 32. The interior of the cylinder 32 is constituted with, sequentially from the feed opening 40, a feed section (the zone indicated by A) that carries out fixed-quantity transport of the cellulose acylate resin fed from the feed opening 40, a compression section (the zone indicated by B) that kneads and compresses the cellulose acylate resin, and a metering section (the zone indicated by C) that meters the kneaded and compressed cellulose acylate resin. The cellulose acylate resin that has been melted in the extruder 22 is continuously transferred from a discharge opening 42 to the die 24.

The screw compression ratio of the extruder 22 is set at 2.5 to 4.5, and the L/D is set at 20 to 70. The screw compression ratio as referred to herein is represented by the volume ratio between the feed section A and the metering section C, namely, the volume of the feed section A per unit length divided by the volume of the metering section C per unit length; the screw compression ratio is derived by using the outer diameter d1 of the screw shaft 34 in the feed section A, the outer diameter d2 of the screw shaft 34 in the metering section C, the groove depth a1 in the feed section A, and the groove depth a2 in the metering section C. The L/D value as referred to herein is the ratio of the length (L) of the cylinder to the inner diameter (D) of the cylinder in FIG. 2. The extrusion temperature (the temperature at the exit of the extruder 22) is set at 190 to 240° C. When the temperature inside the extruder 22 exceeds 240° C., it is recommended to dispose a cooler (not shown) between the extruder 22 and the die 24.

The extruder 22 may be a single-screw extruder or a twin-screw extruder. When the screw compression ratio is less than 2.5 to be too small, sufficient kneading cannot be attained to generate nonmolten fraction, and the shear heat generation is also small to result in insufficient melting of the crystal, so that fine crystals tend to remain and bubbles also tend to incorporated in the cellulose acylate film after completion of production. Therefore, when the cellulose acylate film is stretched, the remaining crystals inhibit the stretchability and no sufficient orientation can be attained. On the other hand, when the screw compression ratio exceeds 4.5 to be too large, excessive shear strain is exerted on the resin and the resin tends to be degraded due to the generated heat, and consequently the cellulose acylate film after completion of production tends to be yellowed. The exerted excessive shear strain also causes the scission of molecules leading to decrease in the molecular weight to decrease the mechanical strength of the film. Accordingly, for the purpose of suppressing the yellowing and break due to stretching in the cellulose acylate film after completion of production, the screw compression ratio preferably falls within a range from 2.5 to 4.5, more preferably from 2.8 to 4.2, and particularly preferably from 3.0 to 4.0.

When L/D is smaller than 20 to be too small, insufficient melting and insufficient kneading are caused, and fine crystals tend to remain in the cellulose acylate film after completion of production in a similar manner as in a case of a small compression ratio. On the other hand, when L/D exceeds 70 to be too large, the residence time of the cellulose acylate resin in the extruder 22 becomes too long, and the resin degradation tends to occur. The long residence time also causes the scission of molecules leading to decrease in the molecular weight to decrease the mechanical strength of the film. Accordingly, for the purpose of suppressing the yellowing and break due to stretching in the cellulose acylate film after completion of production, L/D preferably falls within a range from 20 to 70, more preferably from 22 to 45, and particularly preferably from 24 to 40.

When the extrusion temperature (the temperature at the exit of the extruder 22) is lower than 190° C. to be too low, insufficient melting of the crystal is caused and fine crystals tend to remain in the cellulose acylate film after completion of production. Therefore, when the cellulose acylate film is stretched, the remaining crystals inhibit the stretchability and no sufficient orientation can be attained. On the other hand, when the extrusion temperature exceeds 240° C. to be too high, the cellulose acylate resin is degraded and the degree of yellow (YI value) is increased. Accordingly, for the purpose of suppressing the yellowing and break due to stretching in the cellulose acylate film after completion of production, the extrusion temperature preferably falls within a range from 190° C. to 240° C., more preferably from 195° C. to 235° C., and particularly preferably from 200° C. to 230° C.

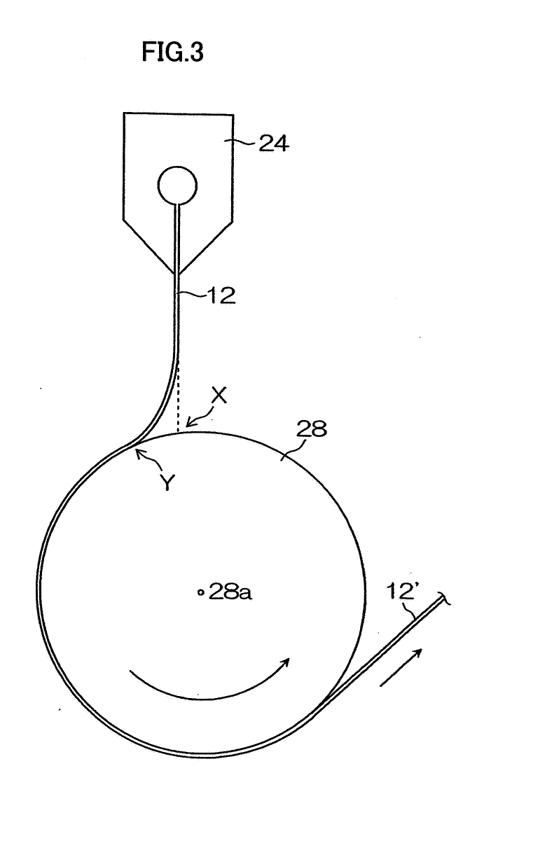

FIG. 3 is a schematic view illustrating how a sheet-shaped molten resin 12 discharged from the die 24 is cast on the cooling drum 28.

As shown in FIG. 3, the sheet-shaped molten resin 12 is discharged from the discharge opening of the die 24, and successively lands on the surface of the cooling drum 28 in such a way that the being-discharged portion of the sheet-shaped molten resin 12 is pulled by the portion, having already been cast on the cooling drum 28, of the sheet-shaped molten resin 12, instead of vertically falling down without altering the direction to land on the surface of the cooling drum 28 serving as the support. In other words, the sheet-shaped molten resin 12 lands on the position Y slightly displaced away along the rotation direction of the cooling drum 28 from the position X on the surface of the cooling drum 28 where the position X is the intersect between the vertical line dropped from the discharge opening of the die 24 and the surface of the cooling drum 28. Here, the length L (melt bead length) of the sheet-shaped molten resin 12 from the discharge opening of the die 24 to the position Y on the surface of the cooling drum 28 is preferably 10 mm to 100 mm. The reason for this is such that: when L is less than 10 mm, the sheet-shaped molten resin 12 discharged from the discharge opening of the die 24 is immediately brought into contact with the cooling drum 28 to be cooled while retaining the high-temperature conditions in the die 24, so that the thickness unevenness is fixed in the cellulose acylate film 12′ without undergoing sufficient leveling; and, on the other hand, when L exceeds 100 mm, the sheet-shaped molten resin 12 tends to be affected by the below-described fluctuation thereof, so that thickness unevenness is caused in the sheet-shaped molten resin 12 by the external force exerting thereto. It is to be noted that the sheet-shaped molten resin usually has a curved shape, so that the length thereof is measured by photography or the like.

In general, the die 24 undergoes the fluctuation due to the recoil at the time of discharging the molten resin, and due to the errors in fixing the supporting members to support the die 24. Consequently, when molten resin is discharged from the die 24, the fluctuation of the die 24 caused by these fluctuations and the external disturbance due to the fluctuation of the die 24 are transmitted to the sheet-shaped molten resin 12, and consequently the sheet-shaped molten resin 12 is fluctuated. At this time, the fluctuation of the die 24 is preferably 30 dB or less. The reason for this is such that when the fluctuation of the die 24 exceeds 30 dB, the fluctuation of the die 24 is transmitted to the sheet-shaped molten resin 12 and the sheet-shaped molten resin 12 is fluctuated so as to be exerted with a needless external force, so that a continuous and periodic step-like thickness unevenness is caused along the lengthwise direction of the sheet-shaped molten resin 12.

Additionally, the cooling drum 28 suffers from a variation of the order of micrometers in the distance from the center 28a of the cooling drum 28 to the circumferential surface of the cooling drum 28 due to the eccentricity of the cooling drum 28, and the production errors in the bearing supporting the cooling drum 28. Consequently, when the cooling drum 28 is rotated, these variations, namely, the fluctuation of the cooling drum 28 and the external disturbance due to this fluctuation are transmitted to the sheet-shaped molten resin 12, so that the sheet-shaped molten resin 12 is made to vibrate.

As described above, the sheet-shaped molten resin 12 undergoes the fluctuations caused by the mechanical vibration due to the die 24 and the rotational vibration due to the cooling drum 28 transmitted to the sheet-shaped molten resin 12. In this case, when the fluctuations are generated in the sheet-shaped molten resin 12 in the vicinity of the surface of the cooling drum 28, the external force caused by the fluctuations and exerting on the resin causes the thickness unevenness in the sheet-shaped molten resin 12. The thickness unevenness in the vicinity of the surface of the cooling drum 28 is cooled by the cooling drum 28 immediately after the generation of the thickness unevenness as compared to the thickness unevenness generated in the vicinity of the discharge opening of the die 24, and hence is characterized by remaining in the sheet-shaped molten resin without undergoing leveling. Accordingly, the suppression of the fluctuation of the sheet-shaped molten resin 12 in the vicinity of the surface of the cooling drum 28 is significant for the purpose of obtaining a cellulose acylate film free from thickness unevenness. Thus, it is preferable to suppress the fluctuation, in the vicinity of the surface of the cooling drum 28, of the sheet-shaped molten resin 12 discharged from the die 24 so as to be 10 dB or less.

According to the embodiment described above, the sheet-shaped molten resin 12 does not undergo the fluctuations due to the air pressure vibration and the mechanical vibration, and hence no continuous and periodic step-like thickness unevenness is generated along the lengthwise direction of the sheet-shaped molten resin. Consequently, there can be provided a cellulose acylate film for use in optical applications and the like, excellent both in appearance and in functions.

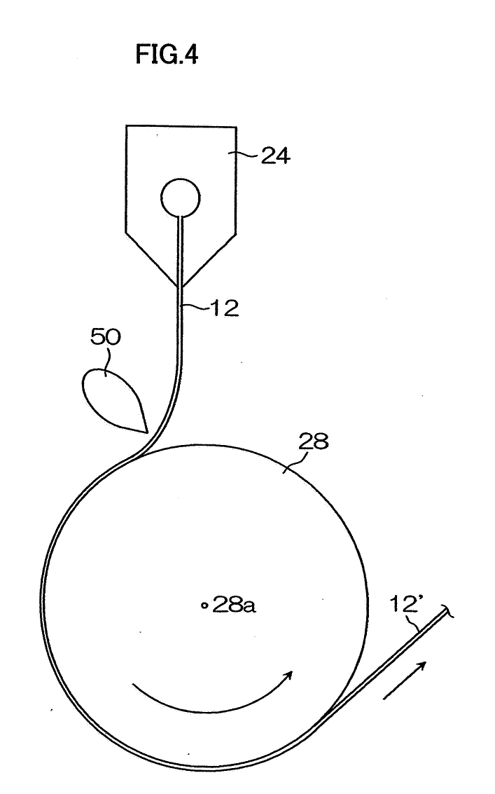

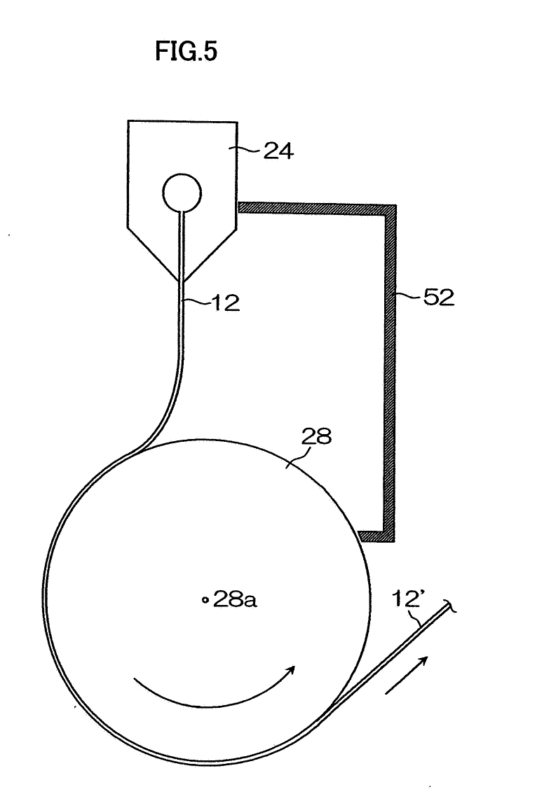

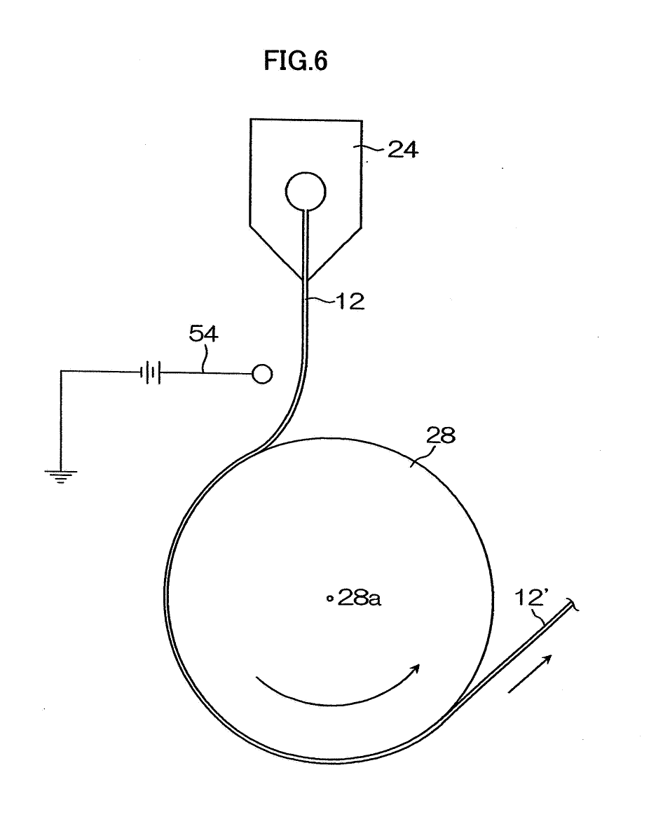

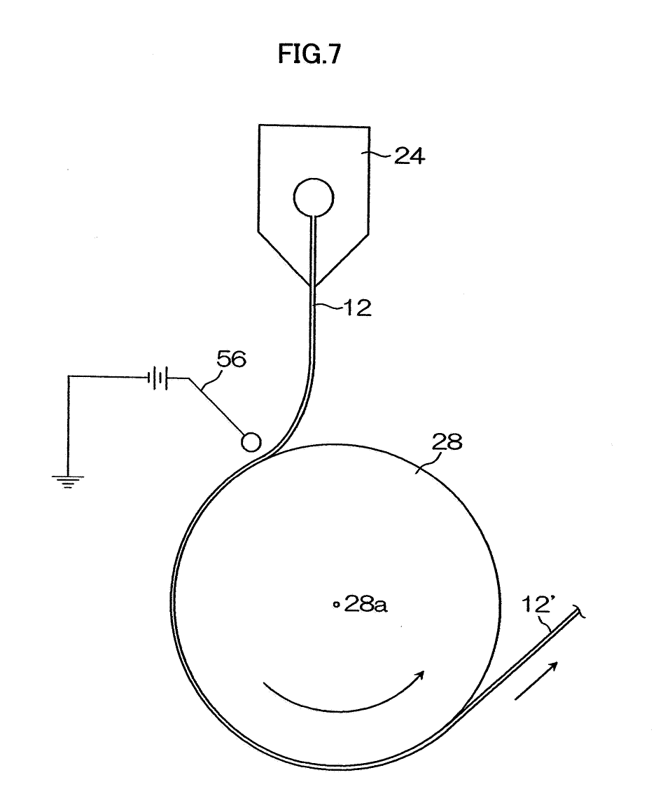

FIGS. 4 to 7 are schematic views illustrating other embodiments. Specifically, FIG. 4 illustrates an example in which an air knife unit 50 is disposed between the die 24 and the cooling drum 28, FIG. 5 illustrates an example in which a back chamber unit 52 is disposed between the die 24 and the cooling drum 28, FIG. 6 illustrates an example in which a static electricity application unit 54 is disposed between the die 24 and the cooling drum 28, and FIG. 7 illustrates an example in which an edge pinning unit 56 is disposed between the die 24 and the cooling drum 28.

Hereinafter, the parts common to those in the above-described embodiment are given the same symbols as in the above-described embodiment, and the detailed description of such parts will be omitted.

For example, as shown in FIG. 4, an air knife unit 50 may be disposed between the die 24 and the cooling drum 28 in such a way that air is blown from the front side of the rotation direction of the cooling drum 28 to the sheet-shaped molten resin 12. The air knife unit 50 has a structure in which the air fed from a high pressure blower (not shown) is made to pass through flow straightening plates installed inside the air knife unit 50, and is blown out from a slit-shaped aperture laterally in parallel with the widthwise direction of the sheet-shaped molten resin 12. Consequently, the sheet-shaped molten resin 12 is pushed against the outer surface of the cooling drum 28, and the fluctuation width of the sheet-shaped molten resin 12 is thereby made small, so that the sheet-shaped molten resin 12 can be prevented from generating the fluctuation as a cause for the thickness unevenness, immediately before the sheet-shaped molten resin 12 lands on the cooling drum 28.

Additionally as shown in FIG. 5, a back chamber unit 52 may be disposed on the side opposite to the rotation direction of the cooling drum 28 in such a way that the reduced pressure applied to the sheet-shaped molten resin 12 can be sufficiently controlled and the back chamber unit 52 is not brought into contact with the sheet-shaped molten resin 12. The back chamber unit 52 applies a reduced pressure to the sheet-shaped molten resin 12 discharged from the die 24 on the upstream side of the rotation direction of the cooling drum 28. Consequently, the sheet-shaped molten resin 12 is indirectly attracted to the outer surface of the cooling drum 28, and the fluctuation width of the sheet-shaped molten resin 12 is thereby made small, so that the sheet-shaped molten resin 12 can be prevented from generating the fluctuation as a cause for the thickness unevenness, immediately before the sheet-shaped molten resin 12 lands on the cooling drum 28.

Further, as shown in FIG. 6, a static electricity application unit 54 may be disposed between the die 24 and the cooling drum 28 in such a way that static electricity can be applied to the sheet-shaped molten resin 12 before the sheet-shaped molten resin 12 lands on the surface of the cooling drum 28. The static electricity application unit 54 applies static electricity to the sheet-shaped molten resin 12. Consequently, the sheet-shaped molten resin 12 electrostatically adheres to the outer surface of the cooling drum 28, and the fluctuation width of the sheet-shaped molten resin 12 is thereby made small, so that the sheet-shaped molten resin 12 can be prevented from generating the fluctuation as a cause for the thickness unevenness, immediately before the sheet-shaped molten resin 12 lands on the cooling drum 28.

Furthermore, as shown in FIG. 7, an edge pinning unit 56 may be disposed above the vicinity of the position on the cooling drum 28 where the sheet-shaped molten resin 12 is brought into contact with the cooling drum 28 in such a way that edge pinning can be carried out by imparting electric charge to the vicinity of each of the edges of the sheet-shaped molten resin 12 at a position where the sheet-shaped molten resin 12 is brought into contact with the cooling drum 28. The edge pinning unit 56 imparts electric charge from the edge pinning electrodes only to the vicinity of each of the edges of the sheet-shaped molten resin 12 at a position where the sheet-shaped molten resin 12 is brought into contact with the cooling drum 28. Consequently, the sheet-shaped molten resin 12 is electrically adhered to the outer surface of the cooling drum 28, and hence the deformation (neck in) of the sheet-shaped molten resin 12 in the time interval between the discharge from the die 24 and the landing on the cooling drum 28 can be stabilized.

It is to be noted that the above described air knife unit 50, back chamber unit 52, static electricity application unit 54, and edge pinning unit 56 may be used each alone to be sufficiently effective, and two or more units selected from these units may also be used in combination from the viewpoint of preventing more reliably the generation of the fluctuation of the sheet-shaped molten resin 12 in the vicinity of the surface of the cooling drum 28. Hereinafter, detailed description will be made on the cellulose acylate resin suitable for the present invention, the processing method of the cellulose acylate film, and the like, according to the sequence of the procedures.

(1) Plasticizers

The resin for the production of the cellulose acylate film in the present invention is preferably added with a polyhydric alcohol plasticizer. Such a plasticizer decreases the modulus of elasticity, and also has an effect to reduce the crystal content difference between the front side and the back side.

The content of the polyhydric alcohol plasticizer is preferably 2 to 20% by weight in relation to the cellulose acylate. The content of the polyhydric alcohol plasticizer is preferably 2 to 20% by weight, more preferably 3 to 18% by weight and furthermore preferably 4 to 15% by weight.

When the content of the polyhydric alcohol plasticizer is less than 2% by weight, the above-mentioned effects cannot be sufficiently attained; on the other hand, when larger than 20% by weight, bleeding (surface deposition of the plasticizer) occurs.

Polyol plasticizers practically used in the present invention include: for example, glycerin-based ester compounds such as glycerin ester and diglycerin ester; polyalkylene glycols such as polyethylene glycol and polypropylene glycol; and compounds in which an acyl group is bound to the hydroxyl group of polyalkylene glycol, all of which are highly compatible with cellulose fatty acid ester and produce remarkable thermoplasticization effect.

Specific examples of the glycerin esters include, but are not limited to: glycerin diacetate stearate, glycerin diacetate palmitate, glycerin diacetate mystirate, glycerin diacetate laurate, glycerin diacetate caprate, glycerin diacetate nonanate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate mystirate, glycerin dipropionate palmitate, glycerin dipropionate stearate, glycerin dipropionate oleate, glycerin tributyrate, glycerin tripentanoate, glycerin monopalmitate, glycerin monostearate, glycerin distearate, glycerin propionate laurate and glycerin oleate propionate. Either any one of these glycerin esters alone or two or more of them in combination may be used.

Of these examples, preferable are glycerin diacetate caprylate, glycerin diacetate pelargonate, glycerin diacetate caprate, glycerin diacetate laurate, glycerin diacetate myristate, glycerin diacetate palmitate, glycerin diacetate stearate, and glycerin diacetate oleate.

Specific examples of diglycerin esters include, but are not limited to: mixed acid esters of diglycerin such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramystirate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate mystirate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimystirate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaprate, diglycerin acetate trilaurate, diglycerin acetate trimystirate, diglycerin acetate tripalmitate, diglycerin acetate tristearate, diglycerin acetate trioleate, diglycerin laurate, diglycerin stearate, diglycerin caprylate, diglycerin myristate, and diglycerin oleate. Either any one of these diglycerin esters alone or two or more of them in combination may be used.

Of these examples, preferable are diglycerin tetraacetate, diglycerin tetrapropionate, diglycerin tetrabutyrate, diglycerin tetracaprylate and diglycerin tetralaurate.

Specific examples of polyalkylene glycols include, but are not limited to: polyethylene glycols and polypropylene glycols having an average molecular weight of 200 to 1000. Either any one of these examples or two of more of them in combination may be used.

Specific examples of compounds in which an acyl group is bound to the hydroxyl group of polyalkylene glycol include, but are not limited to: polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristylate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristylate, polyoxypropylene palmitate, polyoxypropylene stearate, polyoxypropylene oleate, and polyoxypropylene linoleate. Either any one of these examples or two or more of them in combination may be used.

To allow these polyols to fully exert the above described effects, it is preferable to perform the melt film forming of cellulose acylate under the following conditions. Specifically, in the film formation process where pellets of the mixture of cellulose acylate and polyol are melt in an extruder and extruded through a T-die, it is preferable to set the temperature of the extruder outlet (T2) higher than that of the extruder inlet (T1), and it is more preferable to set the temperature of the die (T3) higher than T2. In other words, it is preferable to increase the temperature with the progress of melting. The reason for this is that if the temperature of the above mixture is rapidly increased at the inlet, polyol is first melt and liquefied, and cellulose acylate is brought to such a state that it floats on the liquefied polyol and cannot receive sufficient shear force from the screw, which results in occurrence of un-molten cellulose acylate. In such an insufficiently mixed mixture of polyol and cellulose acylate, polyol, as a plasticizer, cannot exert the above described effects; as a result, the occurrence of the difference between both sides of the melt film after melt extrusion cannot be effectively suppressed. Furthermore, such inadequately molten matter results in a fish-eye-like contaminant after the film formation. Such a contaminant is not observed as a brilliant point even through a polarizing plate, but it is visible on a screen when light is projected into the film from its back side. Fish eyes may cause tailing at the outlet of the die, which results in increased number of die lines.

T1 is preferably in the range of 150 to 200° C., more preferably in the range of 160 to 195° C., and more preferably in the range of 165 to 190° C. T2 is preferably in the range of 190 to 240° C., more preferably in the range of 200 to 230° C., and more preferably in the range of 200 to 225° C. It is most important that such melt temperatures T1, T2 are 240° C. or lower. If the temperatures are higher than 240° C., the modulus of elasticity of the formed film tends to be high. The reason is probably that cellulose acylate undergoes decomposition because it is melted at high temperatures, which causes crosslinking in it, and hence increase in modulus of elasticity of the formed film. The die temperature T3 is preferably 200 to less than 235° C., more preferably in the range of 205 to 230° C., and much more preferably in the range of 205 to 225° C.

(2) Stabilizer

In the present invention, it is preferable to use, as a stabilizer, either phosphite compound or phosphite ester compound, or both phosphite compound and phosphite ester compound. This enables not only the suppression of film deterioration with time, but the improvement of die lines. These compounds function as a leveling agent and get rid of the die lines formed due to the irregularities of the die.

The amount of these stabilizers mixed is preferably 0.005 to 0.5% by weight, more preferably 0.01 to 0.4% by weight, and much more preferably 0.02 to 0.3% by weight of the resin mixture.

(i) Phosphite Stabilizer

Specific examples of preferred phosphite color protective agents include, but are not limited to: phosphite color protective agents expressed by the following chemical formulas (general formulas) (1) to (3). 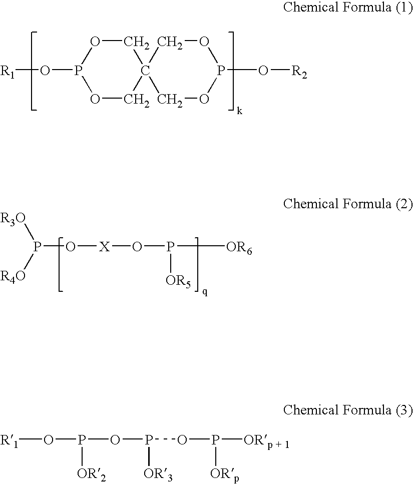
(In the above chemical formulas (1) to (3), R₁, R₂, R₃, R₄, R₅, R₆, R′₁, R′₂, R′₃ . . . R′ₙ, R′ₙ₊₁ each represent hydrogen or a group selected from the group consisting of alkyl, aryl, alkoxyalkyl, aryloxyalkyl, alkoxyaryl, arylalkyl, alkylaryl, polyaryloxyalkyl, polyalkoxyalkyl and polyalkoxyaryl which have 4 or more and 23 or less carbon atoms. However, in the chemical formulas (1), (2) and (3), at least one substituent is not hydrogen. X in the phosphite color protective agents expressed by the chemical formula (2) represents a group selected from the group consisting of aliphatic chain, aliphatic chain with an aromatic nucleus on its side chain, aliphatic chain including an aromatic nucleus in it, and the above described chains including two or more oxygen atoms not adjacent to each other, k and q independently representing an integer of 1 or larger, and p an integer of 3 or larger.)

The k, q in the phosphite color protective agents are preferably 1 to 10. If the k and q are 1 or larger, the agents are less likely to volatilize when heating. If they are 10 or smaller, the agents have an improved compatibility with cellulose acetate propionate. Thus the k, q in the above range are preferable. p is preferably 3 to 10. If the p is 3 or more, the agents are less likely to volatilize when heating. If the p is 10 or less, the agents have improved compatibility with cellulose acetate propionate.

Specific examples of preferred phosphite color protective agents expressed by the chemical formula (general formula) (4) below include phosphite color protective agents expressed by the chemical formulas (5) to (8) below.

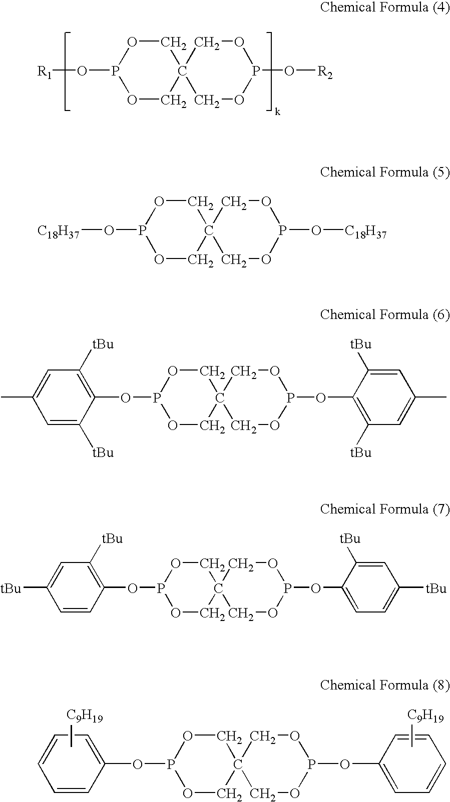

Specific examples of preferred phosphite color protective agents expressed by the chemical formula (general formula) (9) below include phosphite color protective agents expressed by the chemical formulas (10), (11) and (12) below. 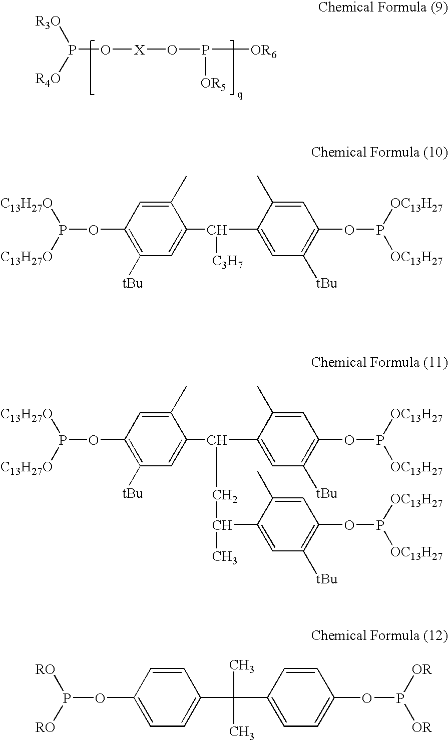
R=alkyl group with 12 to 15 carbon atoms

(ii) Phosphite Ester Stabilizer

Examples of phosphite ester stabilizers include: cyclic neopentane tetraylbis(octadecyl)phosphite, cyclic neopentane tetraylbis(2,4-di-t-butylphenyl)phosphite, cyclic neopentane tetraylbis(2,6-di-t-butyl-4-methylphenyl)phosphite, 2,2-methylenebis(4,6-di-t-butylphenyl)octylphosphite, and tris(2,4-di-t-butylphenyl)phosphite.

(iii) Other Stabilizers

A weak organic acid, thioether compound, or epoxy compound, as a stabilizer, may be mixed with the resin mixture.

Any weak organic acids can be used as a stabilizer in the present invention, as long as they have a pKa of 1 or more, do not interfere with the action of the present invention, and have color preventive and deterioration preventive properties. Examples of such weak organic acids include: tartaric acid, citric acid, malic acid, fumaric acid, oxalic acid, succinic acid and maleic acid. Either any one of these acids alone or two or more of them in combination may be used.

Examples of thioether compounds include: dilauryl thiodipropionate, ditridecyl thiodipropionate, dimyristyl thiodipropionate, distearyl thiodipropionate, and palmityl stearyl thiodipropionate. Either any one of these compounds alone or two or more of them in combination may be used.

Examples of epoxy compounds include: compounds derived from epichlorohydrin and bisphenol A. Derivatives from epichlorohydrin and glycerin or cyclic compounds such as vinyl cyclohexene dioxide or 3,4-epoxy-6-methylcyclohexylmethyl-3,4-epoxy-6-methylcyclohexane carboxylate can also be used. Epoxydized soybean oil, epoxydized castor oil or long-chain α-olefin oxides can also be used. Either any one of these compounds alone or two or more of them in combination may be used.

(3) Cellulose Acylate

<<Cellulose Acylate Resin>>

(Composition, Degree of Substitution)

A cellulose acylate that satisfies all of the requirements expressed by the following formulas (1) to (3) is preferably used in the present invention.
2.0≦X+Y≦3.0 formula (1)
0≦X≦2.0 formula (2)
1.2≦Y≦2.9 formula (3)
(In the above formulas (1) to (3), X represents the substitution degree of acetate group and Y represents the sum of the substitution degrees of propionate group, butyrate group, pentanoyl group and hexanoyl group.)

A cellulose acylate that satisfies all of the requirements expressed by the following formulas (4) to (6) is more preferably used in the present invention.
2.4≦X+Y≦3.0 formula (4)
0.05≦X≦1.8 formula (5)
1.3≦Y≦2.9 formula (6)

A cellulose acylate that satisfies all of the requirements expressed by the following formulas (7) to (9) is still more preferably used in the present invention.
2.5≦X+Y≦2.95 formula (7)
0.1≦X≦1.6 formula (8)
1.4≦Y≦2.9 formula (9)

Thus, the cellulose acylate resin used in the present invention is characterized in that it has propionate, butyrate, pentanoyl and hexanoyl groups introduced into it. Setting the substitution degrees in the above described range is preferable because such setting enables the melt temperature to be decreased and the pyrolysis caused by melt film formation to be suppressed. On the other hand, setting the substitution degrees outside the above described range is not preferable because such setting allows the modulus of elasticity of the film to be outside the range of the present invention.

Either any one of the above cellulose acylates alone or two or more of them in combination may be used. A cellulose acylate into which a polymeric ingredient other than cellulose acylate has been properly mixed may also be used.

In the following a process for producing the cellulose acylate according to the present invention will be described in detail. The raw material cotton for the cellulose acylate according to the present invention or process for synthesizing the same are described in detail in Journal of Technical Disclosure (Laid-Open No. 2001-1745, issued on Mar. 15, 2001, Japan Institute of Invention and Innovation), pp. 7-12.

(Raw Materials and Pretreatment)

As a raw material for cellulose, one from broadleaf pulp, conifer pulp or cotton linter is preferably used. As a raw material for cellulose, a material of high purity whose α-cellulose content is 92% by mass or higher and 99.9% by mass or lower is preferably used.

When the raw material for cellulose is a film-like or bulk material, it is preferable to crush it in advance, and it is preferable to crush the material to such a degree that the cellulose is in the form of fluff.

(Activation)

Preferably, the cellulose material undergoes treatment, prior to acylation, where it is brought into contact with an activator (activation). As an activator, a carboxylic acid or water can be used. When water is used, it is preferable to carry out, after the activation, the steps of: adding excess acid anhydride to the material to dehydrate it; washing the material with carboxylic acid to replace water; and controlling the acylation conditions. The activator can be controlled to any temperature before it is added to the material, and a method for its addition can be selected from the group including spraying, dropping and dipping.

Carboxylic acids preferably used as an activator are those having 2 or more and 7 or less carbon atoms (e.g. acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid, heptanoic acid, cyclohexanecarboxylic acid and benzoic acid), more preferably acetic acid, propionic acid and butyric acid, and particularly preferably acetic acid.

When carrying out the activation, catalyst for acylation such as sulfuric acid can also be added according to the situation. However, addition of a strong acid such as sulfuric acid can sometimes promote depolymerization; thus, preferably the amount of the catalyst added is kept about 0.1% by mass to 10% by mass of the amount of the cellulose. Two or more activators may be used in combination or an acid anhydride of carboxylic acid having 2 or more and 7 or less carbon atoms may also be added.

The amount of activator(s) added is preferably 5% by mass or more of the amount of the cellulose, more preferably 10% by mass or more, and particularly preferably 30% by mass or more. If the amount of activator(s) is larger than the above described minimum value, preferably troubles such that the degree of activating the cellulose is lowered will not occur. The maximum amount of activator(s) added is not particularly limited, as long as it does not decrease the productivity; however, preferably the amount is 100 times the amount of the cellulose or less, in terms of mass, more preferably 20 times the amount of the cellulose or less, and particularly preferably 10 times the amount of the cellulose or less. Activation may be carried out by adding excess activator(s) to the cellulose and then decreasing the amount of the activator(s) through the operation of filtration, air drying, heat drying, distillation under reduced pressure or solvent replacement.

The activation duration is preferably 20 minutes or longer. The maximum duration is not particularly limited, as long as it does not affect the productivity; however, the duration is preferably 72 hours or shorter, more preferably 24 hours or shorter and particularly preferably 12 hours or shorter. The activation temperature is preferably 0° C. or higher and 90° C. or lower, more preferably 15° C. or higher and 80° C. or lower, and particularly preferably 20° C. or higher and 60° C. or lower. The process of the cellulose activation can also be carried out under pressure or reduced pressure. As a heating device, electromagnetic wave such as microwave or infrared ray may be used.

(Acylation)

In the method for producing a cellulose acylate in the present invention, preferably the hydroxyl group of cellulose is acylated by adding an acid anhydride of carboxylic acid to the cellulose to react them in the presence of a Bronsted acid or Lewis acid catalyst.

As a method for obtaining a cellulose-mixed acylate, any one of the methods can be used in which two kinds of carboxylic anhydrides, as acylating agents, are added in the mixed state or one by one to react with cellulose; in which a mixed acid anhydride of two kinds of carboxylic acids (e.g. acetic acid-propionic acid-mixed acid anhydride) is used; in which a carboxylic acid and an acid anhydride of another carboxylic acid (e.g. acetic acid and propionic anhydride) are used as raw materials to synthesize a mixed acid anhydride (e.g. acetic acid-propionic acid-mixed acid anhydride) in the reaction system and the mixed acid anhydride is reacted with cellulose; and in which first a cellulose acylate whose substitution degree is lower than 3 is synthesized and the remaining hydroxyl group is acylated using an acid anhydride or an acid halide.

(Acid Anhydride)

Acid anhydrides of carboxylic acids preferably used are those of carboxylic acids having 2 or more and 7 or less carbon atoms, which include: for example, acetic anhydride, propionic anhydride, butyric anhydride, 2-methylpropionic anhydride, valeric anhydride, 3-methylbutyric anhydride, 2-methylbutyric anhydride, 2,2-dimethylpropionic anhydride (pivalic anhydride), hexanoic anhydride, 2-methylvaleric anhydride, 3-methylvaleric anhydride, 4-methylvaleric anhydride, 2,2-dimethylbutyric anhydride, 2,3-dimethylbutyric anhydride, 3,3-dimethylbutyric anhydride, cyclopentanecarboxylic anhydride, heptanoic anhydride, cyclohexanecarboxylic anhydride and benzoic anhydride. More preferably used are acetic anhydride, propionic anhydride, butyric anhydride, valeric anhydride, hexanoic anhydride and heptanoic anhydride. And particularly preferably used are acetic anhydride, propionic anhydride and butyric anhydride.

To prepare a mixed ester, it is preferable to use two or more of these acid anhydrides in combination. Preferably, the mixing ratio of such acid anhydrides is determined depending on the substitution ratio of the mixed ester. Usually, excess equivalent of acid anhydride(s) is added to cellulose. Specifically, preferably 1.2 to 50 equivalents, more preferably 1.5 to 30 equivalents, and particularly preferably 2 to 10 equivalents of acid anhydride(s) is added to the hydroxyl group of cellulose.

(Catalyst)

As an acylation catalyst for the production of a cellulose acylate in the present invention, preferably a Bronsted acid or a Lewis acid is used. The definitions of Bronsted acid and Lewis acid are described in, for example, “Rikagaku Jiten (Dictionary of Physics and Chemistry)” 5^{th} edition (2000). Examples of preferred Bronsted acids include: sulfuric acid, perchloric acid, phosphoric acid and methanesulfonic acid, benzenesulfonic acid and p-toluenesulfonic acid. Examples of preferred Lewis acids include: zinc chloride, tin chloride, antimony chloride and magnesium chloride.

As the catalyst, sulfuric acid and perchloric acid are preferable, and sulfuric acid is particularly preferable. The amount of the catalyst added is preferably 0.1 to 30% by mass of the amount of cellulose, more preferably 1 to 15% by mass, and particularly preferably 3 to 12% by mass.

(Solvent)

When carrying out acylation, a solvent may be added to the reaction mixture so as to adjust the viscosity, reaction speed, ease of stirring or acyl substitution ratio of the reaction mixture. As such a solvent, dichloromethane, chloroform, a carboxylic acid, acetone, ethyl methyl ketone, toluene, dimethyl sulfoxide or sulfolane can be used. Preferably, a carboxylic acid is used. Examples of carboxylic acids include: for example, those having 2 or more and 7 or less carbon atoms, such as acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, and cyclopentanecarboxylic acid. Preferable are acetic acid, propionic acid and butyric acid. Tow or more of these solvents may be used in the form of a mixture.

(Acylation Conditions)

The acylation may be carried out in such a manner that a mixture of acid anhydride(s), catalyst and, if necessary, solvent(s) is prepared first and then the mixture is mixed with cellulose, or acid anhydride(s), catalyst and, if necessary, solvent(s) are mixed with cellulose one after another. Generally, it is preferable that a mixture of acid anhydride(s) and catalyst or a mixture of acid anhydride(s), catalyst and solvent(s) is prepared first and then the mixture, as an acylating agent, is reacted with cellulose. To suppress the temperature increase in the reactor due to the heat of reaction generated in the acylation, it is preferable to cool such an acylating agent in advance. The cooling temperature is preferably −50° C. to 20° C., more preferably −35° C. to 10° C., and particularly preferably −25° C. to 5° C. An acylating agent may be in the liquid state or in the frozen solid state when added. When added in the frozen solid state, the acylating agent may take the form of a crystal, flake or block.

Acylating agent(s) may be added to cellulose at one time or in installments. Or cellulose may be added to acylating agent(s) at one time or in installments. When adding acylating agent(s) in installments, either a single acylating agent or a plurality of acylating agents each having different compositions may be used. Preferred examples are: 1) adding a mixture of acid anhydride(s) and solvent(s) first and then adding catalyst; 2) adding a mixture of acid anhydride(s), solvent(s) and part of catalyst first and then adding a mixture of the rest of catalyst and solvent(s); 3) adding a mixture of acid anhydride(s) and solvent(s) first and then adding a mixture of catalyst and solvent(s); and 4) adding solvent(s) first and then adding a mixture of acid anhydride(s) and catalyst or a mixture of acid anhydride(s), catalyst and solvent(s).

In the method for producing a cellulose acylate of the present invention, the maximum temperature the reaction system reaches in the acylation is preferably 50° C. or lower, though the acylation of cellulose is exothermic reaction. The reaction temperature 50° C. or lower is preferable because it can prevent depolymerization from progressing, thereby avoiding such a trouble that a cellulose acylate having a polymerization degree suitable for the purpose of the present invention is hard to obtain. The maximum temperature the reaction system reaches in the acylation is preferably 45° C. or lower, more preferably 40° C. or lower, and particularly preferably 35° C. or lower. The reaction temperature may be controlled with a temperature control unit or by controlling the initial temperature of the acylating agent used. The reaction temperature can also be controlled by reducing the pressure in the reactor and utilizing the vaporization heat of the liquid component in the reaction system. Since the exothermic heat in the acylation is larger at the beginning of the reaction, the temperature control can be carried out by cooling the reaction system at the beginning and heating the same afterward. The end point of the acylation can be determined by means of the light transmittance, solvent viscosity, temperature change in the reaction system, solubility of the reaction product in an organic solvent or observation with a polarizing microscope.

The minimum temperature in the reaction is preferably −50° C. or higher, more preferably −30° C. or higher, and particularly preferably −20° C. or higher. Acylation duration is preferably 0.5 hour or longer and 24 hours or shorter, more preferably 1 hour or longer and 12 hours or shorter, and particularly preferably 1.5 hours or longer and 6 hours or shorter. If the duration is 0.5 hours or shorter, the reaction does not sufficiently progress under normal reaction conditions, while if the duration is longer than 24 hours, industrial production of a cellulose acylate is not preferably performed.

(Reaction Terminator)

In the method for producing a cellulose acylate used in the present invention, it is preferable to add a reaction terminator after the acylation reaction.

Any reaction terminator may be used, as long as it can decompose acid anhydride(s). Examples of preferred reaction terminators include: water, alcohols (e.g. ethanol, methanol, propanol and isopropyl alcohol), and compositions including the same. The reaction terminators may include a neutralizer as described later. In the addition of a reaction terminator, it is preferable not to add water or an alcohol directly, but to add a mixture with a carboxylic acid such as acetic acid, propionic acid or butyric acid, particularly preferably acetic acid, and water. Doing so prevents the generation of exothermic heat beyond the cooling ability of the reaction unit, thereby avoiding troubles such as decrease in polymerization degree of the cellulose acylate and precipitation of the cellulose acylate in the undesirable form. A carboxylic acid and water can be used at an arbitrary ratio; however, preferably the water content of the mixture is 5% by mass to 80% by mass, more preferably 10% by mass to 60% by mass, and particularly preferably 15% by mass to 50% by mass.

The reaction terminator may be added to the acylation reactor, or the reactants may be added to the container containing the reaction terminator. Preferably, the reaction terminator is added over a period of 3 minutes to 3 hours. The reason for this is that if the time spent on the addition of the reaction terminator is 3 minutes or longer, it is possible to prevent too large an exothermic heat, thereby avoiding troubles, such as decrease in polymerization degree of the cellulose acylate, insufficient hydrolysis of acid anhydride(s), or decrease in stability of the cellulose acylate. And if the time spent on the addition of the reaction terminator is 3 hours or shorter, it is possible to avoid troubles such as decrease in industrial productivity. The time spent on the addition of the reaction terminator is preferably 4 minutes or longer and 2 hours or shorter, more preferably 5 minutes or longer and 1 hour or shorter, and much more preferably 10 minutes or longer and 45 minutes or shorter. The reactor not necessarily requires cooling when the reaction terminator is added; however, to suppress the progress of depolymerization, it is preferable to retard the temperature increase in the reactor by cooling the same. In this respect, cooling the reaction terminator before its addition is also preferable.

(Neutralizer)

In the acylation reaction termination step or after the acylation reaction termination step, to hydrolyze excess carboxylic anhydride remaining in the reaction system or neutralize part of or the whole carboxylic acid and esterifying catalyst in the same, a neutralizer (e.g. carbonate, acetate, hydroxide or oxide of calcium, magnesium, iron, aluminum or zinc) or its solution may be added. Preferred solvents for such a neutralizer include: for example, polar solvents such as water, alcohols (e.g. ethanol, methanol, propanol and isopropyl alcohol), carboxylic acids (e.g. acetic acid, propionic acid and butyric acid), ketones (e.g. acetone and ethyl methyl ketone) and dimethyl sulfoxide; and mixed solvents thereof.

(Partial Hydrolysis)

In the cellulose acylate thus obtained, the sum of the substitution degrees is approximately 3. Then, to obtain a cellulose acylate with desired substitution degree, generally the obtained cellulose acylate is kept at 20 to 90° C. in the presence of a small amount of catalyst (generally acylating catalyst such as remaining sulfuric acid) and water for several minutes to several days so that the ester linkage is partially hydrolyzed and the substitution degree of the acyl group of the cellulose acylate is decreased to a desired degree (so called aging). Since the sulfate ester of cellulose also undergoes hydrolysis during the process of the above partial hydrolysis, the amount of the sulfate ester bound to cellulose can also be decreased by controlling the hydrolysis conditions.

Preferably, the catalyst remaining in the reaction system is completely neutralized with a neutralizer as described above or the solution thereof at the time when a desired cellulose acylate is obtained so as to terminate the partial hydrolysis. It is also preferable to add a neutralizer which forms a salt slightly soluble in the reaction solution (e.g. magnesium carbonate and magnesium acetate) to effectively remove the catalyst (e.g. sulfuric ester) in the solution or bound to the cellulose.

(Filtration)

To remove the unreacted matter, slightly soluble salts or other contaminants in the cellulose acylate or to reduce the amount thereof, it is preferable to filter the reaction mixture (dope). The filtration may be carried out in any step after the completion of acylation and before the reprecipitation of the same. To control the filtration pressure or the handleability of the cellulose acylate, it is preferable to dilute the cellulose acylate with an appropriate solvent prior to filtration.

(Reprecipitation)

An intended cellulose acylate can be obtained by: mixing the cellulose acylate solution thus obtained into a poor solvent, such as water or an aqueous solution of a carboxylic acid (e.g. acetic acid and propionic acid), or mixing such a poor solvent into the cellulose acylate solution, to precipitate the cellulose acylate; washing the precipitated cellulose acylate; and subjecting the washed cellulose acylate to stabilization treatment. The reprecipitation may be performed continuously or in a batchwise operation. It is preferable to control the form of the reprecipitated cellulose acylate or the molecular weight distribution of the same by adjusting the concentration of the cellulose acylate solution and the composition of the poor solvent used according to the substitution pattern or the substitution degree of the cellulose acylate.

(Washing)

Preferably, the produced cellulose acylate undergoes washing treatment. Any washing solvent can be used, as long as it slightly dissolves the cellulose acylate and can remove impurities; however, generally water or hot water is used. The temperature of the washing water is preferably 25° C. to 100° C., more preferably 30° C. to 90° C., and particularly preferably 40° C. to 80° C. Washing may be carried out in so-called batch process where filtration and replacement are repeated or with continuous washing equipment. It is preferable to reuse, as a poor solvent, the liquid waste generated during the processes of reprecipitation and washing or to recover and reuse the solvent such as carboxylic acid by use of means such as distillation.

The progress of washing may be traced by any means; however, preferred means of tracing include: for example, hydrogen ion concentration, ion chromatography, electrical conductivity, ICP, elemental analysis, and atomic absorption spectrometry.

The catalyst (e.g. sulfuric acid, perchloric acid, trifluoroacetic acid, p-toluenesulfonic acid, methanesulfonic acid or zinc chloride), neutralizer (e.g. carbonate, acetate, hydroxide or oxide of calcium, magnesium, iron, aluminum or zinc), reaction product of the neutralizer and the catalyst, carboxylic acid (e.g. acetic acid, propionic acid or butyric acid), reaction product of the neutralizer and the carboxylic acid, etc. in the cellulose acylate can be removed by this washing treatment. This is highly effective in enhancing the stability of the cellulose acylate.

(Stabilization)

To improve the stability of the cellulose acylate and reduce the odor of the carboxylic acid, it is preferable to treat the cellulose acylate having been washed with hot water with an aqueous solution of weak alkali (e.g. carbonate, hydrogencarbonate, hydroxide or oxide of sodium, potassium calcium, magnesium or aluminum).

The amount of the residual purities can be controlled by the amount of washing solution, the temperature or time of washing, the method of stirring, the shape of washing container, or the composition or concentration of stabilizer. In the present invention, the conditions of acylation, partial hydrolysis and washing are set so that the residual sulfate group (on the basis of the sulfur atom content) is 0 to 500 ppm.

(Drying)

In the present invention, to adjust the water content of the cellulose acylate to a desirable value, it is preferable to dry the cellulose acylate. Any drying method can be employed to dry the cellulose acylate, as long as an intended water content can be obtained; however, it is preferable to carry out drying efficiently by either any one of the means such as heating, blast, pressure reduction and stirring alone or two or more of them in combination. The drying temperature is preferably 0 to 200° C., more preferably 40 to 180° C., and particularly preferably 50 to 160° C. The water content of the cellulose acylate of the present invention is preferably 2% by mass or less, more preferably 1% by mass or less, and particularly preferably 0.7% by mass or less.

(Form)

The cellulose acylate of the present invention can take various forms, such as particle, powder, fiber and bulk forms. However, as a raw material for films, the cellulose acylate is preferably in the particle form or in the powder form. Thus, the cellulose acylate after drying may be crushed or sieved to make the particle size uniform or improve the handleability. When the cellulose acylate is in the particle form, preferably 90% by mass or more of the particles used has a particle size of 0.5 to 5 mm. Further, preferably 50% by mass or more of the particles used has a particle size of 1 to 4 mm. Preferably, the particles of the cellulose acylate have a shape as close to a sphere as possible. And the apparent density of the cellulose acylate particles of the present invention is preferably 0.5 to 1.3, more preferably 0.7 to 1.2, and particularly preferably 0.8 to 1.15. The method for measuring the apparent density is specified in JIS K-7365.

The cellulose acylate particles of the present invention preferably have an angle of repose of 10 to 70 degrees, more preferably 15 to 60 degrees, and particularly preferably 20 to 50 degrees.

(Polymerization Degree)

The average polymerization degree of the cellulose acylate preferably used in the present invention is 100 to 300, preferably 120 to 250, and much more preferably 130 to 200. The average polymerization degree can be determined by intrinsic viscosity method by Uda et al. (Kazuo Uda and Hideo Saitoh, Journal of the Society of Fiber Science and Technology, Japan, Vol. 18, No. 1, 105-120, 1962) or by the molecular weight distribution measurement by gel permeation chromatography (GPC). The determination of average polymerization degree is described in detail in Japanese Patent Application Laid-Open No. 9-95538.

In the present invention, the weight average polymerization degree/number average polymerization degree of the cellulose acylate determined by GPC is preferably 1.6 to 3.6, more preferably 1.7 to 3.3, and much more preferably 1.8 to 3.2.

Of the above described kinds of cellulose acylate, either one kind alone or two or more kinds in combination may be used. Cellulose acylate properly mixed with a polymer ingredient other than cellulose acylate may also be used. The polymer ingredient mixed with cellulose acylate is preferably such that it is highly compatible with cellulose ester and its mixture with cellulose acylate, when formed into a film, has a transmission of 80% or more, preferably 90% or more and much more preferably 92% or more.

### SYNTHESIS EXAMPLES OF CELLULOSE ACYLATES

The synthesis examples of the cellulose acylates used in the present invention will be described in more detail below; however, the present invention is not limited to these examples.

### Synthesis Example 1

### Synthesis of Cellulose Acetate Propionate

In a 5-L separable flask, as a reaction vessel, equipped with a reflux device, 150 g of cellulose (hardwood pulp) and 75 g of acetic acid were placed, and the mixture thus obtained was stirred vigorously for 2 hours while being heated in an oil bath adjusted at 60° C. The cellulose thus pretreated was swelled and disintegrated to be fluffy. The reaction vessel was then placed in an ice-water bath set at 2° C. for 30 minutes for cooling.

Separately, a mixture composed of 1545 g of propionic anhydride, as an acylating agent, and 10.5 g of sulfuric acid was prepared. The mixture was cooled to −30° C. and then added, at a time, to the reaction vessel containing the cellulose subjected to the above-mentioned pretreatment. After an elapsed time of 30 minutes, the outside temperature of the reaction vessel was slowly increased to adjust the inside temperature of the reaction vessel so as to be 25° C. at an elapsed time of 2 hours from the addition of the acylating agent. The reaction vessel was then cooled in an ice-water bath set at 5° C., to adjust the inside temperature of the reaction vessel so as to be 10° C. at an elapsed time of 0.5 hour and 23° C. at an elapsed time of 2 hours from the addition of the acylating agent. The reaction mixture was stirred further for 3 hours while the inside temperature was being maintained at 23° C. The reaction vessel was cooled in an ice-water bath set at 5° C., and 120 g of 25% by mass aqueous acetic acid cooled to 5° C. was added over a period of 1 hour. The inside temperature of the reaction vessel was increased to 40° C. and the mixture was stirred for 1.5 hours. Then, a solution of magnesium acetate tetrahydrate dissolved in 50% by mass aqueous acetic acid in an amount of twice the moles of the sulfuric acid was added to the reaction vessel, and the reaction mixture was stirred for 30 minutes. Then, 1 L of 25% by mass aqueous acetic acid, 500 mL of 33% by mass aqueous acetic acid, 1 L of 50% by mass aqueous acetic acid and 1 L of water were added in this order to precipitate the cellulose acetate propionate. The thus obtained precipitate of the cellulose acetate propionate was washed with heated water. By varying the washing conditions in this washing, the cellulose acetate propionate was obtained so as to have a varied amount of the residual sulfate group. After washing, the cellulose acetate propionate was put into a 0.005% by mass aqueous solution of calcium hydroxide. The mixture thus obtained was stirred for 0.5 hour; further the cellulose acetate propionate was washed with water until the pH of the washing waste became 7, and then vacuum-dried at 70° C.

According to 1H-NMR and GPC measurements, the obtained cellulose acetate propionate was found to have a degree of acetylation of 0.30, a degree of propionylation of 2.63 and a polymerization degree of 320. The content of the sulfate group was measured in conformity with ASTM D-817-96.

### Synthesis Example 2

### Synthesis of Cellulose Acetate Butyrate

In a 5-L separable flask, as a reaction vessel, equipped with a reflux device, 100 g of cellulose (hardwood pulp) and 135 g of acetic acid were placed, and the mixture thus obtained was allowed to stand for 1 hour while being heated in an oil bath adjusted at 60° C. Thereafter, the mixture was stirred vigorously for 1 hour while being heated in an oil bath adjusted at 60° C. The cellulose thus pretreated was swelled and disintegrated to be fluffy. The reaction vessel was then placed in an ice-water bath set at 5° C. for 1 hour to cool the cellulose sufficiently.

Separately, a mixture composed of 1080 g of butyric anhydride, as an acylating agent, and 10.0 g of sulfuric acid was prepared. The mixture was cooled to −20° C. and then added, at a time, to the reaction vessel containing the pretreated cellulose. After an elapsed time of 30 minutes, the outside temperature of the reaction vessel was increased up to 20° C., and the mixture was allowed to react for 5 hours. The reaction vessel was then cooled in an ice-water bath set at 5° C., and 2400 g of 12.5% by mass aqueous acetic acid cooled to approximately 5° C. was added over a period of 1 hour. The inside temperature of the reaction vessel was increased to 30° C. and the mixture was stirred for 1 hour. Then, 100 g of a 50% by mass aqueous solution of magnesium acetate tetrahydrate was added to the reaction vessel and the reaction mixture was stirred for 30 minutes. Then, 1000 g of acetic acid and 2500 g of 50% by mass aqueous acetic acid were added gradually to precipitate the cellulose acetate butyrate. The thus obtained precipitate of the cellulose acetate butyrate was washed with heated water. By varying the washing conditions in this washing, the cellulose acetate butyrate was obtained so as to have a varied amount of the residual sulfate group. After washing, the cellulose acetate butyrate was put into a 0.005% by mass aqueous solution of calcium hydroxide. The mixture thus obtained was stirred for 0.5 hour; further the cellulose acetate butyrate was washed with water until the pH of the washing waste became 7, and then dried at 70° C. The obtained cellulose acetate butyrate was found to have a degree of acetylation of 0.84, a degree of butyrylation of 2.12 and a polymerization degree of 268.

(4) Other Additives

(i) Matting Agent

Preferably, fine particles are added as a matting agent. Examples of fine particles used in the present invention include: those of silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Fine particles containing silicon are preferable because they can decrease the turbidity of the cellulose acylate film. Fine particles of silicon dioxide are particularly preferable. Preferably, the fine particles of silicon dioxide have an average primary particle size of 20 nm or less and an apparent specific gravity of 70 g/liter or more. Those having an average primary particle size as small as 5 to 16 nm are more preferable, because they enable the haze of the film produced to be decreased. The apparent specific gravity is preferably 90 to 200 g/liter or more and more preferably 100 to 200 g/liter more. The larger the apparent specific gravity, the more preferable, because fine particles of silicon dioxide having a larger apparent specific gravity make it possible to prepare a dispersion of higher concentration, thereby improving the haze and the agglomerates.

These fine particles generally form secondary particles having an average particle size of 0.1 to 3.0 μm, which exist as agglomerates of primary particles in a film and form irregularities 0.1 to 3.0 μm in size on the film surface. The average secondary particle size is preferably 0.2 μm or more and 1.5 μm or less, more preferably 0.4 μm or more and 1.2 μm or less, and most preferably 0.6 μm or more and 1.1 μm or less. The primary particle size and the secondary particle size are determined by observing the particles in the film with a scanning electron microscope and using the diameter of the circle circumscribing each particle as a particle size. The average particle size is obtained by averaging the 200 determinations resulting from observation at different sites.

As fine particles of silicon dioxide, those commercially available, such as Aerosil R972, R972V, R974, R812, 200, 200V, 300, R202, OX50 and TT600 (manufactured by Nippon Aerosil Co., LTD), can be used. As fine particles of zirconium oxide, those on the market under the trade name of Aerosil R976 and R811 (manufactured by Nippon Aerosil Co., Ltd.) can be used.

Of these fine particles, Aerosil 200V and Aerosil R972V are particularly preferable, because they are fine particles of silicon dioxide having an average primary particle size of 20 nm or less and an apparent specific gravity of 70 g/liter more and they produce a large effect of reducing friction coefficient of the optical film produced while keeping the turbidity of the same low.

(ii) Other Additives

Various additives other than the above described matting agent, such as ultraviolet light absorbers (e.g. hydroxybenzophenone compounds, benzotriazole compounds, salicylate ester compounds and cyanoacrylate compounds), infrared absorbers, optical adjusters, surfactants and odor-trapping agents (e.g. amine), can be added to the cellulose acylate of the present invention. The materials preferably used are described in detail in Journal of Technical Disclosure Laid-Open No. 2001-1745 (issued on Mar. 15, 2001, Japan Institute of Invention and Innovation), pp. 17-22.

As infrared absorbers, for example, those described in Japanese Patent Application Laid-Open No. 2001-194522 can be used, while as ultraviolet light absorbers, for example, those described in Japanese Patent Application Laid-Open No. 2001-151901 can be used. Both the infrared absorber content and the ultraviolet light absorber content of the cellulose acylate are preferably 0.001 to 5% by mass.

Examples of optical adjusters include retardation adjusters. And those described in, for example, Japanese Patent Application Laid-Open Nos. 2001-166144, 2003-344655, 2003-248117 and 2003-66230 can be used. The use of such a retardation adjuster makes it possible to control the in-plane retardation (Re) and the retardation across the thickness (Rth) of the film produced. Preferably, the amount of the retardation adjuster added is 0 to 10% by weight, more preferably 0 to 8% by weight, and much more preferably 0 to 6% by weight.

(5) Physical Properties of Cellulose Acylate Mixture

The above described cellulose acylate mixtures (mixtures of cellulose acylate, plasticizer, stabilizer and other additives) preferably satisfy the following physical properties.

(i) Loss in Weight

In the thermoplastic cellulose acetate propionate composition of the present invention, the loss in weight on heating at 220° C. is 5% by weight or less. The term “loss in weight on heating” herein used means the loss in weight at 220° C. of a sample when the temperature of the sample is increased from room temperature at a temperature increasing rate of 10° C./min in an atmosphere of nitrogen gas. The loss in weight on heating of cellulose acylate can be 5% by weight or less by allowing cellulose acylate film to take the above described mixture form. The loss in weight on heating of a cellulose acylate mixture is more preferably 3% by weight or less and much more preferably 1% by weight or less. Keeping the loss in weight on heating of a cellulose acylate mixture in the above described range makes it possible to suppress the trouble occurring in the film formation (generation of air bubbles).

(ii) Melt Viscosity

In the thermoplastic cellulose acetate propionate composition of the present invention, preferably the melt viscosity at 220° C., 1 sec⁻¹ is 100 to 1000 Pa·sec, more preferably 200 to 800 Pa·sec, and much more preferably 300 to 700 Pa·sec. Allowing the thermoplastic cellulose acetate propionate composition to have such a higher melt viscosity prevents the composition from being stretched under tension at the die outlet, thereby preventing the optical anisotropy (retardation) caused by stretch orientation from increasing.

Such viscosity adjustment can be performed by any means. For example, the adjustment can be performed by adjusting the polymerization degree of cellulose acylate or the amount of an additive such as a plasticizer.

(6) Pelletization

The above described cellulose acylate and additives are preferably mixed and pelletized prior to melt film formation.

In pelletization, it is preferable to dry the cellulose acylate and additives in advance; however, if a vented extruder is used, the drying step can be omitted. When drying is performed, a drying method can be employed in which the cellulose acylate and additives are heated in a heating oven at 90° C. for 8 hours or more, though drying methods applicable in the present invention are not limited to this. Pelletization can be performed in such a manner that after melting the above described cellulose acylate and additives at temperatures of 150° C. or higher and 250° C. or lower on a twin-screw kneading extruder, the molten mixture is extruded in the form of noodles, and the noodle-shaped mixture is solidified in water, followed by cutting. Pelletization may also be performed by underwater cutting in which the above described cellulose acylate and additives are melted on an extruder and extruded through a ferrule directly in water, and cutting is performed in water while carrying out extrusion.

Any known extruder, such as a single screw extruder, a non-intermeshing counter-rotating twin-screw extruder, an intermeshing counter-rotating twin-screw extruder, or an intermeshing corotating twin-screw extruder, can be used, as long as it enables sufficient melt kneading.

Preferably, the pellet size is such that the cross section is 1 mm² or larger and 300 mm² or smaller and the length is 1 mm or longer and 30 mm or shorter and more preferably the cross section is 2 mm² or larger and 100 mm² or smaller and the length is 1.5 mm or longer and 10 mm or shorter.

In pelletization, the above described additives may be fed through a raw material feeding opening or a vent located midway along the extruder.

The number of revolutions of the extruder is preferably 10 rpm or more and 1000 rpm or less, more preferably 20 rpm or more and 700 rpm or less, and much more preferably 30 rpm or more and 500 rpm or less. If the rotational speed is lower than the above described range, the residence time of the cellulose acylate and additives is increased, which undesirably causes heat deterioration of the mixture, and hence decrease in molecular weight and increase in color change to yellow. Further, if the rotational speed is higher than the above described range, molecule breakage by shear is more likely to occur, which gives rise to problems of decrease in molecular weight and increase in crosslinked gel.

The extrusion residence time in pelletization is preferably 10 seconds or longer and 30 minutes or shorter, more preferably 15 seconds or longer and 10 minutes or shorter, and much more preferably 30 seconds or longer and 3 minutes or shorter. As long as the resin mixture is sufficiently melted, shorter residence time is preferable, because shorter residence time enables the deterioration of resin or occurrence of yellowish color to be suppressed.

(7) Melt Film Formation

(i) Drying

The cellulose acylate mixture palletized by the above described method is preferably used for the melt film formation, and the water content in the pellets is preferably decreased prior to the melt film formation.

In the present invention, to adjust the water content in the cellulose acylate to a desirable amount, it is preferable to dry the cellulose acylate. Drying is often carried out using an air dehumidification drier, but the method of drying is not limited to any specific one, as long as an intended water content is obtained (preferably drying is carried out efficiently by either any one of methods, such as heating, air blasting, pressure reduction and stirring, or two or more of them in combination, and more preferably a drying hopper having an insulating structure is used). The drying temperature is preferably 0 to 200° C., more preferably 40 to 180° C., and particularly preferably 60 to 150° C. Too low a drying temperature is not preferable, because if the drying temperature is too low, drying takes a longer time, and moreover, water content cannot be decreased to an intended value or lower. Too high a drying temperature is not preferable, either, because if the drying temperature is too high, the resin adheres to cause blocking. The amount of drying air used is preferably 20 to 400 m³/hour, more preferably 50 to 300 m³/hour, and particularly preferably 100 to 250 m³/hour. Too small an amount of drying air is not preferable, because if the amount of drying air is too small, drying cannot be carried out efficiently. On the other hand, using too large an amount of drying air is not economical. This is because the drying effect cannot be drastically improved further even by using excess amount of drying air. The dew point of the air is preferably 0 to −60° C., more preferably −10 to −50° C., and particularly preferably −20 to −40° C. The drying time is required to be at least 15 minutes or longer, preferably 1 hour or longer and more preferably 2 hours or longer. However, the drying time exceeding 50 hours dose not drastically decrease the water content further and it might cause deterioration of the resin by heat. Thus, an unnecessarily long drying time is not preferable. In the cellulose acylate of the present invention, the water content is preferably 1.0% by mass or lower, more preferably 0.1% by mass or lower, and particularly preferably 0.01% by mass or lower.

(ii) Melt Extrusion

The above described cellulose acylate resin is fed into a cylinder via the feed opening of an extruder (different from the extruder used for the above described pelletization). The inside of the cylinder consists of: a feed section where the cellulose acylate resin fed through the feed opening is transported in a fixed amount (zone A); a compression section where the cellulose acylate resin is melt-kneaded and compressed (zone B); and a metering section where the melt-kneaded and compressed cellulose acylate resin is metered (zone C), from the feed opening side in this order. The resin is preferably dried by the above described method so as to decrease the water content; however, to prevent the molten resin from being oxidized by the remaining oxygen, more preferably extrusion is performed in a stream of inert gas (nitrogen etc.) or using a vented extruder while performing vacuum evacuation. The screw compression ratio of the extruder is set to 2.5 to 4.5 and the L/D to 20 to 70. The term “screw compression ratio” used herein means the volume ratio of the feed section A to the metering section C, in other words, the volume per unit length of the feed section A divided by the volume per unit length of the metering section C, which is calculated using the outer diameter d1 of the screw shaft of the feed section A, the outer diameter d2 of the screw shaft in the metering section C, the groove depth a1 in the feed section A, and the groove depth a2 in the metering section C. The “L/D” means the ratio of the cylinder length to the inner diameter of the cylinder. Additionally, the extrusion temperature is set at 190 to 240° C. When the temperature inside the extruder exceeds 240° C., it is recommended to dispose a cooler between the extruder and the die.

If the screw compression ratio is as small as less than 2.5, melt-kneading is not sufficiently performed, causing an unmolten part, or the magnitude of heat evolution by shear stress is too small to sufficiently fuse crystals, making fine crystals more likely to remain in the formed cellulose acylate film. Furthermore, the cellulose acylate film more likely contains air bubbles. As a result, the cellulose acylate film having decreased strength is produced, or in stretching of the cellulose acylate film, the remaining crystals inhibit the stretchability of the film, whereby the degree of film orientation cannot be sufficiently increased. Conversely, if the screw compression ratio is as high as more than 4.5, the magnitude of heat evolution by shear stress is so large that the resin becomes more likely to deteriorate, which makes the cellulose acylate film more likely to yellow. Further, too large shear stress causes molecule breakage, which results in decrease in molecular weight, and hence in mechanical strength of the film. Accordingly, to make the formed cellulose acylate film less likely to be yellow and less likely to break in stretching, the screw compression ratio is preferably in the range of 2.5 to 4.5, more preferably in the range of 2.8 to 4.2, and particularly preferably in the range of 3.0 to 4.0.

The L/D as low as less than 20 causes insufficient melting or insufficient kneading, which makes fine crystals more likely to remain in the formed cellulose acylate film, like the case where the compression ratio is too low. Conversely, the L/D as high as more than 70 makes too long the residence time of the cellulose acylate resin in the extruder, which makes the resin more likely to deteriorate. Too long a residence time may cause molecule breakage, which results in decrease in molecular weight, and hence in mechanical strength of the film. Accordingly, to make the formed cellulose acylate film less likely to be yellow and less likely to break in stretching, the L/D is preferably in the range of 20 to 70, more preferably in the range of 22 to 65, and particularly preferably in the range of 24 to 50.

The extrusion temperature is preferably set in the above described temperature range. The cellulose acylate film thus obtained has the following characteristics: a haze of 2.0% or less; and a yellow index (YI value) of 10 or less.

The haze used herein is an index of whether the extrusion temperature is too low or not, in other words, an index of the amount of the crystals remaining in the formed cellulose acylate film. When the haze is more than 2.0%, the strength of the formed cellulose acylate film is likely to deteriorate and the breakage of the film is likely to occur. On the other hand, the yellow index (YI value) is an index of whether the extrusion temperature is too high or not. When the yellow index (YI value) is 10 or less, the formed cellulose acylate film is free from the problem of yellowing.

As regards the type of the extruder, generally a single-screw extruder, relatively lower in equipment cost, is often used; examples of the type of such a single-screw extruder may include the full flight, Maddock and Dulmage types. For the cellulose acylate resin relatively poor in thermal stability, a full flight-type extruder is preferably used. Although the equipment cost is high, it is also possible to use a twin-screw extruder capable of extruding while removing unnecessary volatile components through a vent opening disposed midway along the length of the extruder by altering the screw segments. The types of twin-screw extruders are broadly classified into the corotating type and the counter-rotating type, and both types can be used. Preferable among these is the corotating type because this type hardly generates retaining portions of the resin and has a high self-cleaning performance. Twin-screw extruders are suitable for the film formation of cellulose acetate resin, because the twin-screw extruders are high in kneading performance and resin-feeding performance, and are thereby capable of extruding at low temperatures, although the involved equipment cost is high. A proper disposition of the vent opening in a twin-screw extruder allows to use cellulose acylate pellets or powders as they are in undried conditions. Additionally, the selvedges and the like of the film produced in the course of the film formation can also be reused, as they are, without being dried.

The preferable diameter of the screw varies depending on the intended amount of the cellulose acylate resin extruded per unit time; however, it is preferably 10 mm or larger and 300 mm or smaller, more preferably 20 mm or larger and 250 mm or smaller, and much more preferably 30 mm or larger and 150 mm or smaller.

(iii) Filtration

To filter contaminants in the resin or avoid the damage to the gear pump caused by such contaminants, it is preferable to perform a so-called breaker-plate-type filtration which uses a filter medium provided at the extruder outlet. To filter contaminants with much higher precision, it is preferable to provide, after the gear pump, a filter in which a leaf-type disc filter is incorporated. Filtration can be performed with a single filtering section, or it can be multi-step filtration with a plurality of filtering sections. A filter medium with higher precision is preferably used; however, taking into consideration the pressure resistance of the filter medium or the increase in filtration pressure due to the clogging of the filter medium, the filtration precision is preferably 15 μm to 3 μm and more preferably 10 μm to 3 μm. A filter medium with higher precision is particularly preferably used when a leaf-type disc filter is used to perform final filtration of contaminants. And in order to ensure suitability of the filter medium used, the filtration precision may be adjusted by the number of filter media loaded, taking into account the pressure resistance and filter life. From the viewpoint of being used at high temperature and high pressure, the type of the filter medium used is preferably a steel material. Of the steel materials, stainless steel or steel is particularly preferably used. From the viewpoint of corrosion, desirably stainless steel is used. A filter medium constructed by weaving wires or a sintered filter medium constructed by sintering, for example, metal long fibers or metal powder can be used. However, from the viewpoint of filtration precision and filter life, a sintered filter medium is preferably used.

(iv) Gear Pump

To improve the thickness precision, it is important to decrease the fluctuation in the amount of the discharged resin and it is effective to provide a gear pump between the extruder and the die to feed a fixed amount of cellulose acylate resin through the gear pump. A gear pump is such that it includes a pair of gears—a drive gear and a driven gear—in mesh, and it drives the drive gear to rotate both the gears in mesh, thereby sucking the molten resin into the cavity through the suction opening formed on the housing and discharging a fixed amount of the resin through the discharge opening formed on the same housing. Even if there is a slight change in the resin pressure at the tip of the extruder, the gear pump absorbs the change, whereby the change in the resin pressure in the downstream portion of the film forming apparatus is kept very small, and the fluctuation in the film thickness is improved. The use of a gear pump makes it possible to keep the fluctuation of the resin pressure at the die within the range of ±1%.

To improve the fixed-amount feeding performance of the gear pump, a method can also be used in which the pressure before the gear pump is controlled to be constant by varying the number of revolution of the screw. Or the use of a high-precision gear pump is also effective in which three or more gears are used to eliminate the fluctuation in gear of a gear pump.

Other advantages of using a gear pump are such that it makes possible the film formation while reducing the pressure at the tip of the screw, which would be expected to reduce the energy consumption, prevent the increase in resin temperature, improve the transportation efficiency, decrease in the residence time of the resin in the extruder, and decrease the L/D of the extruder. Furthermore, when a filter is used to remove contaminants, if a gear pump is not used, the amount of the resin fed from the screw can sometimes vary with increase in filtration pressure. However, this variation in the amount of resin fed from the screw can be eliminated by using a gear pump. On the other hand, disadvantages of using a gear pump are such that: it may increase the length of the equipment used, depending on the selection of equipment, which results in a longer residence time of the resin in the equipment; and the shear stress generated at the gear pump portion may cause the breakage of molecule chains. Thus, care must be taken when using a gear pump.

Preferably, the residence time of the resin, from the time the resin enters the extruder through the feed opening to the time it goes out of the die, is 2 minutes or longer and 60 minutes or shorter, more preferably 3 minutes or longer and 40 minutes or shorter, and much more preferably 4 minutes or longer and 30 minutes or shorter.

If the flow of polymer circulating around the bearing of the gear pump is not smooth, the seal by the polymer at the driving portion and the bearing portion becomes poor, which may cause the problem of producing wide fluctuations in measurements and feeding and extruding pressures. Thus, the gear pump (particularly clearances thereof) should be designed to match to the melt viscosity of the cellulose acylate resin. In some cases, the portion of the gear pump where the cellulose acylate resin resides can be a cause of the resin's deterioration. Thus, preferably the gear pump has a structure which allows the residence time of the cellulose acylate resin to be as short as possible. The polymer tubes or adapters that connect the extruder with a gear pump or a gear pump with the die should be so designed that they allow the residence time of the cellulose acylate resin to be as short as possible. Furthermore, to stabilize the extrusion pressure of the cellulose acylate whose melt viscosity is highly temperature-dependent, preferably the fluctuation in temperature is kept as narrow as possible. Generally, a band heater, which requires lower equipment costs, is often used for heating polymer tubes; however, it is more preferable to use a cast-in aluminum heater which is less susceptible to temperature fluctuation. Further, for the purpose of stabilizing the discharge pressure in the extruder as described above, melting is preferably conducted by heating the extruder barrel with 3 or more and 20 or less divided heaters.

(v) Die

With the extruder constructed as above, the cellulose acylate is melted and continuously fed into a die, if necessary, through a filter or gear pump. Any type of commonly used die, such as T-die, fish-tail die or hanger coat die, may be used, as long as it allows the residence time of the molten resin to be short. Further, a static mixer can be introduced right before the T-die to increase the temperature uniformity. The clearance at the outlet of the T-die can be 1.0 to 5.0 times the film thickness, preferably 1.2 to 3 times the film thickness, and more preferably 1.3 to 2 times the film thickness. If the lip clearance is less than 1.0 time the film thickness, it is difficult to obtain a sheet whose surface state is good. Conversely, if the lip clearance is more than 5.0 times the film thickness, undesirably the thickness precision of the sheet is decreased. A die is very important equipment which determines the thickness precision of the film to be formed, and thus, one that can severely control the film thickness is preferably used. Although commonly used dies can control the film thickness at intervals of 40 to 50 mm, dies of a type which can control the film thickness at intervals of 35 mm or less and more preferably at intervals of 25 mm or less are preferable. In the cellulose acylate resin, since its melt viscosity is highly temperature-dependent and shear-rate-dependent, it is important to design a die that causes the least possible temperature unevenness and the least possible flow-rate unevenness across the width. The use of an automated thickness adjusting die, which measures the thickness of the film downstream, calculates the thickness deviation and feeds the calculated result back to the thickness adjustment, is also effective in decreasing fluctuations in thickness in the long-term continuous production of the cellulose acylate film.

In producing films, a single-layer film forming apparatus, which requires lower producing costs, is generally used. However, depending on the situation, it is also possible to use a multi-layer film forming apparatus to produce a film having 2 types or more of structure, in which an outer layer is formed as a functional layer. Generally, preferably a functional layer is laminated thin on the surface of the cellulose acylate film, but the layer-layer ratio is not limited to any specific one.

(vi) Cast

The molten resin extruded in the form of a sheet from the die in the above described manner is cooled and solidified on cooling drums to obtain a film. In this cooling and solidifying operation, preferably the adhesion of the extruded sheet of the molten resin to the cooling drums is enhanced by any of the methods, such as electrostatic application method, air-knife method, air-chamber method, vacuum-nozzle method or touch-roll method. These adhesion enhancing methods may be applied to either the whole surface or part of the surface of the sheet resulting from melt extrusion. A method, called as edge pinning, in which cooling drums are adhered to the edges of the film alone is often employed, but the adhesion enhancing method used in the present invention is not limited to this method.

Preferably, the molten resin sheet is cooled little by little using a plurality of cooling drums. Generally, such cooling is often performed using 3 cooling drums, but the number of cooling drums used is not limited to 3. The diameter of the cooling drums is preferably 100 mm or larger and 1000 mm or smaller and more preferably 150 mm or larger and 1000 mm or smaller. The spacing between the two adjacent drums of the plurality of drums is preferably 1 mm or larger and 50 mm or smaller and more preferably 1 mm or larger and 30 mm or smaller, in terms of face-face spacing.

The temperature of cooling drums is preferably 60° C. or higher and 160° C. or lower, more preferably 70° C. or higher and 150° C. or lower, and much more preferably 80° C. or higher and 140° C. or lower. The cooled and solidified sheet is then stripped off from the cooling drums, passed through take-off rollers (a pair of nip rollers), and wound up. The wind-up speed is preferably 10 m/min or higher and 100 m/min or lower, more preferably 15 m/min or higher and 80 m/min or lower, and much more preferably 20 m/min or higher and 70 m/min or lower.

The width of the film thus formed is preferably 0.7 m or more and 5 m or less, more preferably 1 m or more and 4 m or less, and much more preferably 1.3 m or more and 3 m or less. The thickness of the unstretched film thus obtained is preferably 30 μm or more and 400 μm or less, more preferably 40 μm or more and 300 μm or less, and much more preferably 50 μm or more and 200 μm or less.

When so-called touch roll method is used, the surface of the touch roll used may be made of resin, such as rubber or Teflon, (trade name) or metal. A roll, called as flexible roll, can also be used whose surface gets a little depressed by the pressure of a metal roll having a decreased thickness when the flexible roll and the metal roll touch with each other, and their pressure contact area is increased.

The temperature of the touch roll is preferably 60° C. or higher and 160° C. or lower, more preferably 70° C. or higher and 150° C. or lower, and much more preferably 80° C. or higher and 140° C. or lower.

(vii) Winding Up

Preferably, the sheet thus obtained is wound up with its edges trimmed away. The portions having been trimmed off may be reused as a raw material for the same kind of film or a different kind of film, after undergoing grinding or after undergoing granulation, or depolymerization or re-polymerization depending on the situation. Any type of trimming cutter, such as a rotary cutter, shearing blade or knife, may be used. The material of the cutter may be either carbon steel or stainless steel. Generally, a carbide-tipped blade or ceramic blade is preferably used, because use of such a blade makes the life of a cutter longer and suppresses the production of cuttings.

It is also preferable, from the viewpoint of preventing the occurrence of scratches on the sheet, to provide, prior to winding up, a laminating film at least on one side of the sheet. Preferably, the wind-up tension is 1 kg/m (in width) or higher and 50 kg/m (in width) or lower, more preferably 2 kg/m (in width) or higher and 40 kg/m (in width) or lower, and much more preferably 3 kg/m (in width) or higher and 20 kg/m (in width) or lower. If the wind-up tension is lower than 1 kg/m (in width), it is difficult to wind up the film uniformly. Conversely, if the wind-up tension is higher than 50 kg/m (in width), undesirably the film is too tightly wound, whereby the appearance of wound film deteriorates, and the knot portion of the film is stretched due to the creep phenomenon, causing surging in the film, or residual double refraction occurs due to the extension of the film. Preferably, the winding up is performed while detecting the wind-up tension with a tension control provided midway along the line and controlling the same to be constant. When there is a difference in the film temperature depending on the spot on the film forming line, a slight difference in the film length can sometimes be created due to thermal expansion, and thus, it is necessary to adjust the draw ratio of the nip rolls so that tension higher than a prescribed one should not be applied to the film.

Preferably, the winding up of the film is performed while tapering the amount of the film to be wound according to the winding diameter so that a proper wind-up tension is kept, though it can be performed while keeping the wind-up tension constant by the control with the tension control. Generally, the wind-up tension is decreased little by little with increase in the winding diameter; however, it can sometimes be preferable to increase the wind-up tension with increase in the winding diameter.

The above-mentioned winding up method is a general one, and is applicable to the case where the heat treatment of the present invention is conducted offline. When the heat treatment of the present invention is conducted online, the wind-up tension is required to be controlled as described above.

(viii) Physical Properties of Unstretched Cellulose Acylate Film

In the unstretched cellulose acylate film thus obtained, preferably Re=0 to 20 nm and Rth=0 to 80 nm, more preferably Re=0 to 15 nm and Rth=0 to 70 nm, and furthermore preferably Re=0 to 10 nm and Rth=0 to 60 nm. Re and Rth represent the in-plane retardation and the thicknesswise retardation, respectively. Re is measured using KOBRA 21ADH (manufactured by Oji Scientific Instruments Co., Ltd.) while allowing light to enter the unstretched cellulose acylate film normal to its surface. Rth is calculated based on three retardation measurements: the Re measured as above, and the Rth measured while allowing light to enter the film from the direction inclined at angles of +40°, −40°, respectively, to the direction normal to the film using the slow axis in plane as a tilt axis (rotational axis). Preferably, the angle θ between the direction of the film formation (lengthwise direction) and the slow axis of the Re of the film is made as close to 0°, +90° or −90° as possible.

The total light transmittance is preferably 90% to 100%, more preferably 91% to 99%, and much more preferably 92% to 98%. Preferably, the haze is 0 to 1%, more preferably 0 to 0.8% and much more preferably 0 to 0.6%.

Preferably, the thickness unevenness in any of the lengthwise direction and the widthwise direction is 0% or more and 4% or less, more preferably 0% or more and 3% or less, and much more preferably 0% or more and 2% or less.

Preferably the modulus in tension is 1.5 kN/mm² or more and 3.5 kN/mm² or less, more preferably 1.7 kN/mm² or more and 2.8 kN/mm² or less, and much more preferably 1.8 kN/mm² or more and 2.6 kN/mm² or less.

Preferably the breaking extension is 3% or more and 100% or less, more preferably 5% or more and 80% or less, and much more preferably 8% or more and 50% or less.

Preferably the Tg (this indicates the Tg of the film, that is, the Tg of the mixture of cellulose acylate and additives) is 95° C. or higher and 145° C. or lower, more preferably 100° C. or higher and 140° C. or lower, and much more preferably 105° C. or higher and 135° C. or lower.

Preferably the dimensional change by heat at 80° C. per day is 0% or higher ±1% or less in any of the longitudinal direction and the transverse direction, more preferably 0% or higher ±0.5% or less, and much more preferably 0% or higher ±0.3% or less.

Preferably the water permeability at 40° C., 90% rh is 300 g/m²·day or higher and 1000 g/m²·day or lower, more preferably 400 g/m²·day or higher and 900 g/m²·day or lower, and much more preferably 500 g/m²·day or higher and 800 g/m²·day or lower.

Preferably the equilibrium water content at 25° C., 80% rh is 1% by weight or higher and 4% by weight or lower, more preferably 1.2% by weight or higher and 3% by weight or lower, and much more preferably 1.5% by weight or higher and 2.5% by weight or lower.

(8) Stretching

The film formed by the above described process may be stretched. The Re and Rth of the film can be controlled by stretching.

Preferably, stretching is carried out at temperatures of Tg or higher and Tg+50° C. or lower, more preferably at temperatures of Tg+3° C. or higher and Tg+30° C. or lower, and much more preferably at temperatures of Tg+5° C. or higher and Tg+20° C. or lower. Preferably, the stretch magnification is 1% or higher and 300% or lower at least in one direction, more preferably 2% or higher and 250% or lower, and much more preferably 3% or higher and 200% or lower. The stretching can be performed equally in both longitudinal and transverse directions; however, preferably it is performed unequally so that the stretch magnification in one direction is larger than that of the other direction. Either the stretch magnification in the longitudinal direction (MD) or that in the transverse direction (TD) may be made larger. Preferably, the smaller value of the stretch magnification is 1% or more and 30% or less, more preferably 2% or more and 25% or less, and much more preferably 3% or more and 20% or less. Preferably, the larger one is 30% or more and 300% or less, more preferably 35% or more and 200% or less, and much more preferably 40% or more and 150% or less. The stretching operation can be carried out in one step or in a plurality of steps. The term “stretch magnification” used herein means the value obtained using the following equation.
Stretch magnification (%)=100×{(length after stretching)−(length before stretching)}/(length before stretching)

The stretching may be performed in the longitudinal direction by using 2 or more pairs of nip rolls and controlling the peripheral velocity of the pairs of nip rolls so that the velocity of the pair on the outlet side is faster than that of the other one(s) (longitudinal stretching) or in the transverse direction (in the direction perpendicular to the longitudinal direction) while allowing both ends of the film to be gripped by a chuck (transverse stretching). Further, the stretching may be performed using the simultaneous biaxial stretching method described in Japanese Patent Application Laid-Open Nos. 2000-37772, 2001-113591 and 2002-103445.

In the longitudinal stretching, the Re-to-Rth ratio can be freely controlled by controlling the value obtained by dividing the distance between two pairs of nip rolls by the width of the film (length-to-width ratio). In other words, the ratio Rth/Re can be increased by decreasing the length-to-width ratio. Further, Re and Rth can also be controlled by combining the longitudinal stretching and the transverse stretching. In other words, Re can be decreased by decreasing the difference between the percent of longitudinal stretch and the percent of the transverse stretch, while Re can be increased by increasing the difference between the same.

Preferably, the Re and Rth of the cellulose acylate film thus stretched satisfy the following formulas,
Rth≧Re
200≧Re≧0
500≧Rth≧30
more preferably,
Rth≧Re×1.1
150≧Re≧10
400≧Rth≧50
and furthermore preferably,
Rth≧Re×1.2
100≧Re≧20
350≧Rth≧80

Preferably, the angle θ between the film forming direction (longitudinal direction) and the slow axis of Re of the film is as close to 0°, +90° or −90° as possible. Specifically, in the longitudinal stretching, preferably the angle θ is as close to 0° as possible, and it is preferably 0±3°, more preferably 0±2° and much more preferably 0±1°. In the transverse stretching, the angle θ is preferably 90±3° or −90±3°, more preferably 90±2° or −90±2°, and much more preferably 90±1° or −90±1°.

The thickness of the cellulose acylate film after stretching is preferably 15 μm or more and 200 μm or less, more preferably 30 μm or more and 170 μm or less, and furthermore preferably 40 μm or more and 140 μm or less. In each of the lengthwise direction and the widthwise direction, the thickness unevenness is preferably 0% or more and 3% or less, more preferably 0% or more and 2% or less, and furthermore preferably 0% or more and 1% or less.

The physical properties of the stretched cellulose acylate film are preferably in the following range.

Preferably, the modulus in tension is 1.5 kN/mm² or more and less than 3.0 kN/mm², more preferably 1.7 kN/mm² or more and 2.8 kN/mm² or less, and much more preferably 1.8 kN/mm² or more and 2.6 kN/mm² or less.

Preferably, the breaking extension is 3% or more and 100% or less, more preferably 5% or more and 80% or less, and much more preferably 8% or more and 50% or less.

Preferably, the Tg (this indicates the Tg of the film, that is, the Tg of the mixture of cellulose acylate and additives) is 95° C. or higher and 145° C. or lower, more preferably 100° C. or higher and 140° C. or lower, and much more preferably 105° C. or higher and 135° C. or lower.

Preferably, the dimensional change by heat at 80° C. per day is 0% or higher ±1% or less in any of the longitudinal direction and the transverse direction, more preferably 0% or higher ±0.5% or less, and much more preferably 0% or higher ±0.3% or less.

Preferably, the water permeability at 40° C., 90% is 300 g/m²·day or higher and 1000 g/m²·day or lower, more preferably 400 g/m²·day or higher and 900 g/m²·day or lower, and much more preferably 500 g/m²·day or higher and 800 g/m²·day or lower.

Preferably, the equilibrium water content at 25° C., 80% rh is 1% by weight or higher and 4% by weight or lower, more preferably 1.2% by weight or higher and 3% by weight or lower, and much more preferably 1.5% by weight or higher and 2.5% by weight or lower. The thickness is preferably 30 μm or more and 200 μm or less, more preferably 40 μm or more and 180 μm or less, and much more preferably 50 μm or more and 150 μm or less.

The haze is 0% or more and 3% or less, more preferably 0% or more and 2% or less, and much more preferably 0% or more and 1% or less. The total light transmittance is preferably 90% or higher and 100% or lower, more preferably 91% or higher and 99% or lower, and much more preferably 92% or higher and 98% or lower.

(9) Surface Treatment

The adhesion of both unstretched and stretched cellulose acylate films to each functional layer (e.g. undercoat layer and back layer) can be improved by subjecting them to surface treatment. Examples of types of surface treatment applicable include: treatment using glow discharge, ultraviolet irradiation, corona discharge, flame, or acid or alkali. The glow discharge treatment mentioned herein may be treatment using low-temperature plasma generated in a low-pressure gas at 10⁻³ to 20 Torr. Or plasma treatment at atmospheric pressure is also preferable. Plasma excitation gases are gases that undergo plasma excitation under the above described conditions, and examples of such gases include: argon, helium, neon, krypton, xenon, nitrogen, carbon dioxide, flons such as tetrafluoromethane, and the mixtures thereof. These are described in detail in Journal of Technical Disclosure (Laid-Open No. 2001-1745, issued on Mar. 15, 2001, by Japan Institute of Invention and Innovation), 30-32. In the plasma treatment at atmospheric pressure, which has attracted considerable attention in recent years, for example, irradiation energy of 20 to 500 Kgy is used at 10 to 1000 Kev, and preferably irradiation energy of 20 to 300 Kgy is used at 30 to 500 Kev. Of the above described types of treatment, most preferable is alkali saponification, which is extremely effective as surface treatment for cellulose acylate films. Specific examples of such treatment applicable include: those described in Japanese Patent Application Laid-Open Nos. 2003-3266, 2003-229299, 2004-322928 and 2005-76088.

Alkali saponification may be carried out by immersing the film in a saponifying solution or by coating the film with a saponifying solution. The saponification by immersion can be achieved by allowing the film to pass through a bath, in which an aqueous solution of NaOH or KOH with pH of 10 to 14 has been heated to 20° C. to 80° C., over 0.1 to 10 minutes, neutralizing the same, water-washing the neutralized film, followed by drying.

The saponification by coating can be carried out using a coating method such as dip coating, curtain coating, extrusion coating, bar coating or E-coating. A solvent for alkali-saponification solution is preferably selected from solvents that allow the saponifying solution to have excellent wetting characteristics when the solution is applied to a transparent substrate; and allow the surface of a transparent substrate to be kept in a good state without causing irregularities on the surface. Specifically, alcohol solvents are preferable, and isopropyl alcohol is particularly preferable. An aqueous solution of surfactant can also be used as a solvent. As an alkali for the alkali-saponification coating solution, an alkali soluble in the above described solvent is preferable, and KOH or NaOH is more preferable. The pH of the alkali-saponification coating solution is preferably 10 or more and more preferably 12 or more. Preferably, the alkali saponification reaction is carried at room temperature for 1 second or longer and 5 minutes or shorter, more preferably for 5 seconds or longer and 5 minutes or shorter, and particularly preferably for 20 seconds or longer and 3 minutes or shorter. It is preferable to wash the saponifying solution-coated surface with water or an acid and wash the surface with water again after the alkali saponification reaction. The coating-type saponification and the removal of orientation layer described later can be performed continuously, whereby the number of the producing steps can be decreased. The details of these saponifying processes are described in, for example, Japanese Patent Application Laid-Open No. 2002-82226 and WO 02/46809.

To improve the adhesion of the unstretched or stretched cellulose acylate film to each functional layer, it is preferable to provide an undercoat layer on the cellulose acylate film. The undercoat layer may be provided after carrying out the above described surface treatment or without the surface treatment. The details of the undercoat layers are described in Journal of Technical Disclosure (Laid-Open No. 2001-1745, issued on Mar. 15, 2001, by Japan Institute of Invention and Innovation), p. 32.

These surface-treatment step and under-coat step can be incorporated into the final part of the film forming step, or they can be performed independently, or they can be performed in the functional-layer providing process.

(10) Providing Functional Layer

Preferably, the stretched and unstretched cellulose acylate films of the present invention are combined with any one of the functional layers described in detail in Journal of Technical Disclosure (Laid-Open No. 2001-1745, issued on Mar. 15, 2001, by Japan Institute of Invention and Innovation), 32-45. Particularly preferable is providing a polarizing layer (polarizing plate), optical compensation layer (optical compensation film), antireflection layer (antireflection film) or hard coat layer.

(i) Providing Polarizing Layer (Preparation of Polarizing Plate)

[Materials Used for Polarizing Layer]

At the present time, generally, commercially available polarizing layers are prepared by immersing stretched polymer in a solution of iodine or a dichroic dye in a bath so that the iodine or dichroic dye penetrates into the binder. Coating-type of polarizing films, represented by those manufactured by Optiva Inc., are also available as a polarizing film. Iodine or a dichroic dye in the polarizing film develops polarizing properties when its molecules are oriented in a binder. Examples of dichroic dyes applicable include: azo dye, stilbene dye, pyrazolone dye, triphenylmethane dye, quinoline dye, oxazine dye, thiazine dye and anthraquinone dye. The dichroic dye used is preferably water-soluble. The dichroic dye used preferably has a hydrophilic substitute (e.g. sulfo, amino, or hydroxyl). Examples of such dichroic dyes include: compounds described in Journal of Technical Disclosure, Laid-Open No. 2001-1745, 58, (issued on Mar. 15, 2001, by Japan Institute of Invention and Innovation).

Any polymer which is crosslinkable in itself or which is crosslinkable in the presence of a crosslinking agent can be used as a binder for polarizing films. And more than one combination thereof can also be used as a binder. Examples of binders applicable include: compounds described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000. Details of denatured polyvinyl alcohol are described in Japanese Patent Application Laid-Open Nos. 8-338913, 9-152509 and 9-316127. For polyvinyl alcohol and denatured polyvinyl alcohol, two or more kinds may be used in combination.

Preferably, the minimum of the binder thickness is 10 μm. For the maximum of the binder thickness, from the viewpoint of light leakage of liquid crystal displays, preferably the binder has the smallest possible thickness. The thickness of the binder is preferably equal to or smaller than that of currently commercially available polarizing plate (about 30 μm), more preferably 25 μm or smaller, and much more preferably 20 μm or smaller.

The binder for polarizing films may be crosslinked. Polymer or monomer that has a crosslinkable functional group may be mixed into the binder. Or a crosslinkable functional group may be provided to the binder polymer itself. Crosslinking reaction is allowed to progress by means of light, heat or pH changes, and a binder having a crosslinked structure can be formed by crosslinking reaction. Examples of crosslinking agents applicable are described in U.S. Pat. (Reissued) No. 23297. Boron compounds (e.g. boric acid and borax) may also be used as a crosslinking agent. The amount of the crosslinking agent added to the binder is preferably 0.1 to 20% by mass of the binder. This allows polarizing devices to have good orientation characteristics and polarizing films to have good damp heat resistance.

The amount of the unreacted crosslinking agent after completion of the crosslinking reaction is preferably 1.0% by mass or less and more preferably 0.5% by mass or less. Restraining the unreacted crosslinking agent to such an amount improves the weatherability of the binder.

[Stretching of Polarizing Film]

Preferably, a polarizing film is dyed with iodine or a dichroic dye after undergoing stretching (stretching process) or rubbing (rubbing process).

In the stretching process, preferably the stretching magnification is 2.5 to 30.0 and more preferably 3.0 to 10.0. Stretching can be dry stretching, which is performed in the air. Stretching can also be wet stretching, which is performed while dry stretching is preferably 2.5 to 5.0, while the stretching magnification in the wet stretching is preferably 3.0 to 10.0. Stretching may be performed parallel to the MD direction (parallel stretching) or in an oblique (oblique stretching). These stretching operations may be performed at one time or in several installments. Stretching can be performed more uniformly even in high-ratio stretching if it is performed in several installments. Oblique stretching in which stretching is performed in an oblique while tilting a film at an angle of 10 degrees to 80 degrees is more preferable.

(I) Parallel Stretching Process

Prior to stretching, a PVA film is swelled. The degree of swelling is 1.2 to 2.0 (ratio of mass before swelling to mass after swelling). After this swelling operation, the PVA film is stretched in a water-based solvent bath or in a dye bath in which a dichroic substance is dissolved at a bath temperature of 15 to 50° C., preferably 17 to 40° C. while continuously conveying the film via a guide roll etc. Stretching can be accomplished in such a manner as to grip the PVA film with 2 pairs of nip rolls and control the conveying speed of nip rolls so that the conveying speed of the latter pair of nip rolls is higher than that of the former pair of nip rolls. The stretching magnification is based on the length of PVA film after stretching/the length of the same in the initial state ratio (hereinafter the same), and from the viewpoint of the above described advantages, the stretching magnification is preferably 1.2 to 3.5 and more preferably 1.5 to 3.0. After this stretching operation, the film is dried at 50° C. to 90° C. to obtain a polarizing film.

(II) Oblique Stretching Process

Oblique stretching can be performed by the method described in Japanese Patent Application Laid-Open No. 2002-86554 in which a tenter that projects on a tilt is used. This stretching is performed in the air; therefore, it is necessary to allow a film to contain water so that the film is easy to stretch. Preferably, the water content in the film is 5% or higher and 100% or lower, the stretching temperature is 40° C. or higher and 90° C. or lower, and the humidity during the stretching operation is preferably 50% rh or higher and 100% rh or lower.

The absorbing axis of the polarizing film thus obtained is preferably 10 degrees to 80 degrees, more preferably 30 degrees to 60 degrees, and much more preferably substantially 45 degrees (40 degrees to 50 degrees).

[Lamination]

The above described stretched and unstretched cellulose acylate films having undergone saponification and the polarizing layer prepared by stretching are laminated to prepare a polarizing plate. They may be laminated in any direction, but preferably they are laminated so that the angle between the direction of the film casting axis and the direction of the polarizing plate stretching axis is 0 degree, 45 degrees or 90 degrees.

Any adhesive can be used for the lamination. Examples of adhesives applicable include: PVA resins (including denatured PVA such as acetoacetyl, sulfonic, carboxyl or oxyalkylene group) and aqueous solutions of boron compounds. Of these adhesives, PVA resins are preferable. The thickness of the adhesive layer is preferably 0.01 to 10 μm and particularly preferably 0.05 to 5 μm, on a dried layer basis.

Examples of configurations of laminated layers are as follows:

a. A/P/A

b. A/P/B

c. A/P/T

d. B/P/B

e. B/P/T

where A represents an unstretched film of the present invention, B a stretched film of the present invention, T a cellulose triacetate film (Fujitack), and P a polarizing layer. In the configurations a. and b., A and B may be cellulose acetate having the same composition, or they may be different. In the configuration d., two Bs may be cellulose acetate having the same composition, or they may be different, and their stretching rates may be the same or different. When sheets of polarizing plate are used as an integral part of a liquid crystal display, they may be integrated into the display with either side of them facing the liquid crystal surface; however, in the configurations b., e., preferably B is allowed to face the liquid crystal surface.

In the liquid crystal displays into which sheets of polarizing plate are integrated, usually a substrate including liquid crystal is arranged between two sheets of polarizing plate; however, the sheets of polarizing plate of a to e of the present invention and commonly used polarizing plate (T/P/T) can be freely combined. On the outermost surface of a liquid crystal display, however, preferably a transparent hard coat layer, an anti-glare layer, antireflection layer and the like is provided, and as such a layer, any one of layers described later can be used.

Preferably, the sheets of polarizing plate thus obtained have a high light transmittance and a high degree of polarization. The light transmittance of the polarizing plate is preferably in the range of 30 to 50% at a wavelength of 550 nm, more preferably in the range of 35 to 50%, and most preferably in the range of 40 to 50%. The degree of polarization is preferably in the range of 90 to 100% at a wavelength of 550 nm, more preferably in the range of 95 to 100%, and most preferably in the range of 99 to 100%.

The sheets of polarizing plate thus obtained can be laminated with a λ/4 plate to create circularly polarized light. In this case, they are laminated so that the angle between the slow axis of the λ/4 plate and the absorbing axis of the polarizing plate is 45 degrees. Any λ/4 plate can be used to create circularly polarized light; however, preferably one having such wavelength-dependency that retardation is decreased with decrease in wavelength is used. More preferably, a polarizing film having an absorbing axis which tilts 20 degrees to 70 degrees in the longitudinal direction and a λ/4 plate that includes an optically anisotropic layer made up of a liquid crystalline compound are used.

These sheets of polarizing plate may include a protective film laminated on one side and a separate film on the other side. Both protective film and separate film are used for protecting sheets of polarizing plate at the time of their shipping, inspection and the like.

(ii) Providing Optical Compensation Layer (Preparation of Optical Compensation Film)

An optically anisotropic layer is used for compensating the liquid crystalline compound in a liquid crystal cell in black display by a liquid crystal display. It is prepared by forming an orientation film on each of the stretched and unstretched cellulose acylate films and providing an optically anisotropic layer on the orientation film.

[Orientation Film]

An orientation film is provided on the above described stretched and unstretched cellulose acylate films which have undergone surface treatment. This film has the function of specifying the orientation direction of liquid crystalline molecules. However, this film is not necessarily indispensable constituent of the present invention. This is because a liquid crystalline compound plays the role of the orientation film, as long as the oriented state of the liquid crystalline compound is fixed after it undergoes orientation treatment. In other words, the sheets of polarizing plate of the present invention can also be prepared by transferring only the optically anisotropic layer on the orientation film, where the orientation state is fixed, on the polarizing plate.

An orientation film can be provided using a technique such as rubbing of an organic compound (preferably polymer), oblique deposition of an inorganic compound, formation of a micro-groove-including layer, or built-up of an organic compound (e.g. ω-tricosanic acid, dioctadecyl methyl ammonium chloride, methyl stearate) by Langmuir-Blodgett technique (LB membrane). Orientation films in which orientation function is produced by the application of electric field, electromagnetic field or light irradiation are also known.

Preferably, the orientation film is formed by rubbing of polymer. As a general rule, the polymer used for the orientation film has a molecular structure having the function of orienting liquid crystalline molecules.

In the present invention, preferably the orientation film has not only the function of orienting liquid crystalline molecules, but also the function of combining a side chain having a crosslinkable functional group (e.g. double bond) with the main chain or the function of introducing a crosslinkable functional group having the function of orienting liquid crystalline molecules into a side chain.

Either polymer which is crosslinkable in itself or polymer which is crosslinkable in the presence of a crosslinking agent can be used for the orientation film. And a plurality of the combinations thereof can also be used. Examples of such polymer include: those described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000.

Side chains having the function of orienting liquid crystal molecules generally have a hydrophobic group as a functional group. The kind of the functional group is determined depending on the kind of liquid crystalline molecules and the oriented state required. For example, a denatured group of denatured polyvinyl alcohol can be introduced by copolymerization denaturation, chain transfer denaturation or block polymerization denaturation. Examples of denatured groups include: hydrophilic groups (e.g. carboxylic, sulfonic, phosphonic, amino, ammonium, amide and thiol groups); hydrocarbon groups with 10 to 100 carbon atoms; fluorine-substituted hydrocarbon groups; thioether groups; polymerizable groups (e.g. unsaturated polymerizable groups, epoxy group, azirinyl group); and alkoxysilyl groups (e.g. trialkoxy, dialkoxy, monoalkoxy). Specific examples of these denatured polyvinyl alcohol compounds include: those described in Japanese Patent Application Laid-Open No. 2000-155216, columns [0022] to [0145], Japanese Patent Application Laid-Open No. 2002-62426, columns [0018] to [0022].

Combining a side chain having a crosslinkable functional group with the main chain of the polymer of an orientation film or introducing a crosslinkable functional group into a side chain having the function of orienting liquid crystal molecules makes it possible to copolymerize the polymer of the orientation film and the polyfunctional monomer contained in the optically anisotropic layer. As a result, not only the molecules of the polyfunctional monomer, but also the molecules of the polymer of the orientation film and those of the polyfunctional monomer and the polymer of the orientation film are covalently firmly bonded together. Thus, introduction of a crosslinkable functional group into the polymer of an orientation film enables remarkable improvement in the strength of optical compensation films.

The crosslinkable functional group of the polymer of the orientation film preferably has a polymerizable group, like the polyfunctional monomer. Specific examples of such crosslinkable functional groups include: those described in Japanese Patent Application Laid-Open No. 2000-155216, columns [0080] to [0100]. The polymer of the orientation film can be crosslinked using a crosslinking agent, besides the above described crosslinkable functional groups.

Examples of crosslinking agents applicable include: aldehyde; N-methylol compounds; dioxane derivatives; compounds that function by the activation of their carboxyl group; activated vinyl compounds; activated halogen compounds; isoxazole; and dialdehyde starch. Two or more kinds of crosslinking agents may be used in combination. Specific examples of such crosslinking agents include: compounds described in Japanese Patent Application Laid-Open No. 2002-62426, columns [0023] to [0024]. Aldehyde, which is highly reactive, particularly glutaraldehyde is preferably used as a crosslinking agent.

The amount of the crosslinking agent added is preferably 0.1 to 20% by mass of the polymer and more preferably 0.5 to 15% by mass. The amount of the unreacted crosslinking agent remaining in the orientation film is preferably 1.0% by mass or less and more preferably 0.5% by mass or less. Controlling the amount of the crosslinking agent and unreacted crosslinking agent in the above described manner makes it possible to obtain a sufficiently durable orientation film, in which reticulation does not occur even after it is used in a liquid crystal display for a long time or it is left in an atmosphere of high temperature and high humidity for a long time.

Basically, an orientation film can be formed by: coating the above described polymer, as a material for forming an orientation film, on a transparent substrate containing a crosslinking agent; heat drying (crosslinking) the polymer; and rubbing the same. The crosslinking reaction may be carried out at any time after the polymer is applied to the transparent substrate, as described above. When a water-soluble polymer, such as polyvinyl alcohol, is used as the material for forming an orientation film, the coating solution is preferably a mixed solvent of an organic solvent having an anti-foaming function (e.g. methanol) and water. The mixing ratio is preferably such that water:methanol=0:100 to 99:1 and more preferably 0:100 to 91:9. The use of such a mixed solvent suppresses the generation of foam, thereby significantly decreasing defects not only in the orientation film, but also on the surface of the optically anisotropic layer.

As a coating method for coating an orientation film, spin coating, dip coating, curtain coating, extrusion coating, rod coating or roll coating is preferably used. Particularly preferably used is rod coating. The thickness of the film after drying is preferably 0.1 to 10 μm. The heat drying can be carried out at 20° C. to 110° C. To achieve sufficient crosslinking, preferably the heat drying is carried out at 60° C. to 100° C. and particularly preferably at 80° C. to 100° C. The drying time can be 1 minute to 36 hours, but preferably it is 1 minute to 30 minutes. Preferably, the pH of the coating solution is set to a value optimal to the crosslinking agent used. When glutaraldehyde is used, the pH is 4.5 to 5.5 and particularly preferably 5.

The orientation film is provided on the stretched and unstretched cellulose acylate films or on the above described undercoat layer. The orientation film can be obtained by crosslinking the polymer layer and providing rubbing treatment on the surface of the polymer layer, as described above.

The above described rubbing treatment can be carried out using a treatment method widely used in the treatment of liquid crystal orientation in LCD. Specifically, orientation can be obtained by rubbing the surface of the orientation film in a fixed direction with paper, gauze, felt, rubber or nylon, polyester fiber and the like. Generally the treatment is carried out by repeating rubbing several times using a cloth in which fibers of uniform length and diameter have been uniformly transplanted.

In the rubbing treatment industrially carried out, rubbing is performed by bringing a rotating rubbing roll into contact with a running film including a polarizing layer. The circularity, cylindricity and deviation (eccentricity) of the rubbing roll are preferably 30 μm or less respectively. The wrap angle of the film wrapping around the rubbing roll is preferably 0.1 to 90°. However, as described in Japanese Patent Application Laid-Open No. 8-160430, if the film is wrapped around the rubbing roll at 360° or more, stable rubbing treatment is ensured. The conveying speed of the film is preferably 1 to 100 m/min. Preferably, the rubbing angle is properly selected from the range of 0 to 60°. When the orientation film is used in liquid crystal displays, the rubbing angle is preferably 40° to 50° and particularly preferably 45°.

The thickness of the orientation film thus obtained is preferably in the range of 0.1 to 10 μm.

Then, liquid crystalline molecules of the optically anisotropic layer are oriented on the orientation film. After that, if necessary, the polymer of the orientation film and the polyfunctional monomer contained in the optically anisotropic layer are reacted, or the polymer of the orientation film is crosslinked using a crosslinking agent.

The liquid crystalline molecules used for the optically anisotropic layer include: rod-shaped liquid crystalline molecules and discotic liquid crystalline molecules. The rod-shaped liquid crystalline molecules and discotic liquid crystalline molecules may be either high-molecular-weight liquid crystalline molecules or low-molecular-weight liquid crystalline molecules, and they include low-molecule liquid crystalline molecules which have undergone crosslinking and do not show liquid crystallinity any more.

[Rod-Shaped Liquid Crystalline Molecules]

Examples of rod-shaped liquid crystalline molecules preferably used include: azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

Rod-shaped liquid crystalline molecules also include metal complexes. Liquid crystal polymer that includes rod-shaped liquid crystalline molecules in its repeating unit can also be used as rod-shaped liquid crystalline molecules. In other words, rod-shaped liquid crystalline molecules may be bonded to (liquid crystal) polymer.

Rod-shaped liquid crystalline molecules are described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Handbook of Liquid Crystal Devices, edited by 142th Committee of Japan Society for the Promotion of Science, Chapter 3.

The index of birefringence of the rod-shaped liquid crystalline molecules is preferably in the range of 0.001 to 0.7.

To allow the oriented state to be fixed, preferably the rod-shaped liquid crystalline molecules have a polymerizable group. As such a polymerizable group, a radically polymerizable unsaturated group or cationically polymerizable group is preferable. Specific examples of such polymerizable groups include: polymerizable groups and polymerizable liquid crystal compounds described in Japanese Patent Application Laid-Open No. 2002-62427, columns [0064] to [0086].

[Discotic Liquid Crystalline Molecules]

Discotic liquid crystalline molecules include: benzene derivatives described in the research report by C. Destrade et al., Mol. Cryst. Vol. 71, 111 (1981); truxene derivatives described in the research report by C. Destrade et al., Mol. Cryst. Vol. 122, 141 (1985) and Physics lett, A, Vol. 78, 82 (1990); cyclohexane derivatives described in the research report by B. Kohne et al., Angew. Chem. Vol. 96, 70 (1984); and azacrown or phenylacetylene macrocycles described in the research report by J. M. Lehn et al., J. Chem. Commun., 1794 (1985) and in the research report by J. Zhang et al., J. Am. Chem. Soc. Vol. 116, 2655 (1994).

Discotic liquid crystalline molecules also include liquid crystalline compounds having a structure in which straight-chain alkyl group, alkoxy group and substituted benzoyloxy group are substituted radially as the side chains of the mother nucleus at the center of the molecules. Preferably, the compounds are such that their molecules or groups of molecules have rotational symmetry and they can provide an optically anisotropic layer with a fixed orientation. In the ultimate state of the optically anisotropic layer formed of discotic liquid crystalline molecules, the compounds contained in the optically anisotropic layer are not necessarily discotic liquid crystalline molecules. The ultimate state of the optically anisotropic layer also contain compounds such that they are originally of low-molecular-weight discotic liquid crystalline molecules having a group reactive with heat or light, but undergo polymerization or crosslinking by heat or light, thereby becoming higher-molecular-weight molecules and losing their liquid crystallinity. Examples of preferred discotic liquid crystalline molecules are described in Japanese Patent Application Laid-Open No. 8-50206. And the details of the polymerization of discotic liquid crystalline molecules are described in Japanese Patent Application Laid-Open No. 8-27284.

To fix the discotic liquid crystalline molecules by polymerization, it is necessary to bond a polymerizable group, as a substitute, to the discotic core of the discotic liquid crystalline molecules. Compounds in which their discotic core and a polymerizable group are bonded to each other via a linking group are preferably used. With such compounds, the oriented state is maintained during the polymerization reaction. Examples of such compounds include: those described in Japanese Patent Application Laid-Open No. 2000-155216, columns [0151] to [0168].

In hybrid orientation, the angle between the long axis (disc plane) of the discotic liquid crystalline molecules and the plane of the polarizing film increases or decreases, across the depth of the optically anisotropic layer, with increase in the distance from the plane of the polarizing film. Preferably, the angle decreases with increase in the distance. The possible changes in angle include: continuous increase, continuous decrease, intermittent increase, intermittent decrease, change including both continuous increase and continuous decrease, and intermittent change including increase and decrease. The intermittent changes include the area midway across the thickness where the tilt angle does not change. Even if the change includes the area where the angle does not change, it does not matter as long as the angle increases or decreased as a whole. Preferably, the angle changes continuously.

Generally, the average direction of the long axis of the discotic liquid crystalline molecules on the polarizing film side can be adjusted by selecting the type of discotic liquid crystalline molecules or the material for the orientation film, or by selecting the method of rubbing treatment. On the other hand, generally the direction of the long axis (disc plane) of the discotic liquid crystalline molecules on the surface side (on the air side) can be adjusted by selecting the type of discotic liquid crystalline molecules or the type of the additives used together with the discotic liquid crystalline molecules. Examples of additives used with the discotic liquid crystalline molecules include: plasticizer, surfactant, polymerizable monomer, and polymer. The degree of the change in orientation in the long axis direction can also be adjusted by selecting the type of the liquid crystalline molecules and that of additives, like the above described cases.

[Other Compositions of Optically Anisotropic Layer]

Use of plasticizer, surfactant, polymerizable monomer, etc. together with the above described liquid crystalline molecules makes it possible to improve the uniformity of the coating film, the strength of the film and the orientation of liquid crystalline molecules. Preferably, such additives are compatible with the liquid crystalline molecules, and they can change the tilt angle of the liquid crystalline molecules or do not inhibit the orientation of the liquid crystalline molecules.

Examples of polymerizable monomers applicable include radically polymerizable or cationically polymerizable compounds. Preferable are radically polymerizable polyfunctional monomers which are copolymerizable with the above described polymerizable-group containing liquid crystalline compounds. Specific examples are those described in Japanese Patent Application Laid-Open No. 2002-296423, columns [0018] to [0020]. The amount of the above described compounds added is generally in the range of 1 to 50% by mass of the discotic liquid crystalline molecules and preferably in the range of 5 to 30% by mass.

Examples of surfactants include traditionally known compounds; however, fluorine compounds are particularly preferable. Specific examples of fluorine compounds include compounds described in Japanese Patent Application Laid-Open No. 2001-330725, columns [0028] to [0056].

Preferably, polymers used together with the discotic liquid crystalline molecules can change the tilt angle of the discotic liquid crystalline molecules.

Examples of polymers applicable include cellulose esters. Examples of preferred cellulose esters include those described in Japanese Patent Application Laid-Open No. 2000-155216, column [0178]. Not to inhibit the orientation of the liquid crystalline molecules, the amount of the above described polymers added is preferably in the range of 0.1 to 10% by mass of the liquid crystalline molecules and more preferably in the range of 0.1 to 8% by mass.

The discotic nematic liquid crystal phase-solid phase transition temperature of the discotic liquid crystalline molecules is preferably 70 to 300° C. and more preferably 70 to 170° C.

[Formation of Optically Anisotropic Layer]

An optically anisotropic layer can be formed by coating the surface of the orientation film with a coating solution that contains liquid crystalline molecules and, if necessary, polymerization initiator or any other ingredients described later.

As a solvent used for preparing the coating solution, an organic solvent is preferably used. Examples of organic solvents applicable include: amides (e.g. N,N-dimethylformamide); sulfoxides (e.g. dimethylsulfoxide); heterocycle compounds (e.g. pyridine); hydrocarbons (e.g. benzene, hexane); alkyl halides (e.g. chloroform, dichloromethane, tetrachloroethane); esters (e.g. methyl acetate, butyl acetate); ketones (e.g. acetone, methyl ethyl ketone); and ethers (e.g. tetrahydrofuran, 1,2-dimethoxyethane). Alkyl halides and ketones are preferably used. Two or more kinds of organic solvent can be used in combination.

Such a coating solution can be applied by a known method (e.g. wire bar coating, extrusion coating, direct gravure coating, reverse gravure coating or die coating method).

The thickness of the optically anisotropic layer is preferably 0.1 to 20 μm, more preferably 0.5 to 15 μm, and most preferably 1 to 10 μm.

[Fixation of Orientation State of Liquid Crystalline Molecules]

The oriented state of the oriented liquid crystalline molecules can be maintained and fixed. Preferably, the fixation is performed by polymerization. Types of polymerization include: heat polymerization using a heat polymerization initiator and photopolymerization using a photopolymerization initiator. For the fixation, photopolymerization is preferably used.

Examples of photopolymerization initiators include: α-carbonyl compounds (described in U.S. Pat. Nos. 2,367,661 and 2,367,670); acyloin ethers (described in U.S. Pat. No. 2,448,828); α-hydrocarbon-substituted aromatic acyloin compounds (U.S. Pat. No. 2,722,512); multi-nucleus quinone compounds (described in U.S. Pat. Nos. 3,046,127 and 2,951,758); combinations of triarylimidazole dimmer and p-aminophenyl ketone (described in U.S. Pat. No. 3,549,367); acridine and phenazine compounds (described in Japanese Patent Application Laid-Open No. 60-105667 and U.S. Pat. No. 4,239,850); and oxadiazole compounds (described in U.S. Pat. No. 4,212,970).

The amount of the photopolymerization initiators used is preferably in the range of 0.01 to 20% by mass of the solid content of the coating solution and more preferably in the range of 0.5 to 5% by mass.

Light irradiation for the polymerization of liquid crystalline molecules is preferably performed using ultraviolet light.

Irradiation energy is preferably in the range of 20 mJ/cm² to 50 J/cm², more preferably 20 to 5000 mJ/cm², and much more preferably 100 to 800 mJ/cm². To accelerate the photopolymerization, light irradiation may be performed under heat.

A protective layer may be provided on the surface of the optically anisotropic layer.

Combining the optical compensation film with a polarizing layer is also preferable. Specifically, an optically anisotropic layer is formed on a polarizing film by coating the surface of the polarizing film with the above described coating solution for an optically anisotropic layer. As a result, thin polarizer, in which stress generated with the dimensional change of polarizing film (distortion×cross-sectional area×modulus of elasticity) is small, can be prepared without using a polymer film between the polarizing film and the optically anisotropic layer. Installing the polarizing plate according to the present invention in a large-sized liquid crystal display device enables high-quality images to be displayed without causing problems such as light leakage.

Preferably, stretching is performed while keeping the tilt angle of the polarizing layer and the optical compensation layer to the angle between the transmission axis of the two sheets of polarizing plate laminated on both sides of a liquid crystal cell constituting LCD and the longitudinal or transverse direction of the liquid crystal cell. Generally the tilt angle is 45°. However, in recent years, transmissive-, reflective-, and semi-transmissive-liquid crystal display devices have been developed in which the tilt angle is not always 45°, and thus, it is preferable to adjust the stretching direction arbitrarily to the design of each LCD.

[Liquid Crystal Display Devices]

Liquid crystal modes in which the above described optical compensation film is used will be described.

(TN-Mode Liquid Crystal Display Devices)

TN-mode liquid crystal display devices are most commonly used as a color TFT liquid crystal display device and described in a large number of documents. The oriented state in a TN-mode liquid crystal cell in the black state is such that the rod-shaped liquid crystalline molecules stand in the middle of the cell while the rod-shaped liquid crystalline molecules lie near the substrates of the cell.

(OCB-Mode Liquid Crystal Display Devices)

An OCB-mode liquid crystal cell is a bend orientation mode liquid crystal cell where the rod-shaped liquid crystalline molecules in the upper part of the liquid cell and those in the lower part of the liquid cell are oriented in substantially opposite directions (symmetrically). Liquid crystal displays using a bend orientation mode liquid crystal cell are disclosed in U.S. Pat. Nos. 4,583,825 and 5,410,422. A bend orientation mode liquid crystal cell has a self-compensation function since the rod-shaped liquid crystalline molecules in the upper part of the liquid cell and those in the lower part are symmetrically oriented. Thus, this liquid crystal mode is also referred to as OCB (Optically Compensatory Bend) liquid crystal mode.

Like in the TN-mode cell, the oriented state in an OCB-mode liquid crystal cell in the black state is also such that the rod-shaped liquid crystalline molecules stand in the middle of the cell while the rod-shaped liquid crystalline molecules lie near the substrates of the cell.

(VA-Mode Liquid Crystal Display Devices)

VA-mode liquid crystal cells are characterized in that in the cells, rod-shaped liquid crystalline molecules are oriented substantially vertically when no voltage is applied. The VA-Mode Liquid Crystal Cells Include: (1) a VA-Mode Liquid Crystal Cell in a narrow sense where rod-shaped liquid crystalline molecules are oriented substantially vertically when no voltage is applied, while they are oriented substantially horizontally when a voltage is applied (Japanese Patent Application Laid-Open No. 2-176625); (2) a MVA-mode liquid crystal cell obtained by introducing multi-domain switching of liquid crystal into a VA-mode liquid crystal cell to obtain wider viewing angle, (SID 97, Digest of Tech. Papers (Proceedings) 28 (1997) 845), (3) a n-ASM-mode liquid crystal cell where rod-shaped liquid crystalline molecules undergo substantially vertical orientation when no voltage is applied, while they undergo twisted multi-domain orientation when a voltage is applied (Proceedings 58 to 59 (1998), Symposium, Japanese Liquid Crystal Society); and (4) a SURVAIVAL-mode liquid crystal cell (reported in LCD international 98).

(IPS-Mode Liquid Crystal Display Devices)

IPS-mode liquid crystal cells are characterized in that in the cells, rod-shaped liquid crystalline molecules are oriented substantially horizontally in plane when no voltage is applied and switching is performed by changing the orientation direction of the crystal in accordance with the presence or absence of application of voltage. Specific examples of IPS-mode liquid crystal cells applicable include those described in Japanese Patent Application Laid-Open Nos. 2004-365941, 2004-12731, 2004-215620, 2002-221726, 2002-55341 and 2003-195333.

(Other Modes of Liquid Crystal Display Devices)

In ECB-mode, STN (Super Twisted Nematic)-mode, FLC (Ferroelectric Liquid Crystal)-mode, AFLC (Anti-ferroelectric Liquid Crystal)-mode, and ASM (Axially Symmetric Aligned Microcell)-mode cells, optical compensation can also be achieved with the above described logic. These cells are effective in any of the transmissive-, reflective-, and semi-transmissive-liquid crystal display devices. These are also advantageously used as an optical compensation sheet for GH (Guest-Host)-mode reflective liquid crystal display devices.

Examples of practical applications in which the cellulose derivative films described so far are used are described in Journal of Technical Disclosure (Laid-Open No. 2001-1745, Mar. 15, 2001, issued by Japan Institute of Invention and Innovation), 45-59.

Providing Antireflection Layer (Antireflection Film)

Generally an antireflection film is made up of: a low-refractive-index layer which also functions as a stainproof layer; and at least one layer having a refractive index higher than that of the low-refractive-index layer (i.e. high-refractive-index layer and/or intermediate-refractive-index layer) provided on a transparent substrate.

Methods of forming a multi-layer thin film as a laminate of transparent thin films of inorganic compounds (e.g. metal oxides) having different refractive indices include: chemical vapor deposition (CVD); physical vapor deposition (PVD); and a method in which a film of a colloid of metal oxide particles is formed by sol-gel process from a metal compound such as a metal alkoxide and the formed film is subjected to post-treatment (ultraviolet light irradiation: Japanese Patent Application Laid-Open No. 9-157855, plasma treatment: Japanese Patent Application Laid-Open No. 2002-327310).

On the other hand, there are proposed various antireflection films, as highly productive antireflection films, which are formed by coating thin films of a matrix and inorganic particles dispersing therein in a laminated manner.

There is also provided an antireflection film including an antireflection layer provided with anti-glare properties, which is formed by using an antireflection film formed by coating as described above and providing the outermost surface of the film with fine irregularities.

The cellulose acylate film of the present invention is applicable to antireflection films formed by any of the above described methods, but particularly preferable is the antireflection film formed by coating (coating type antireflection film).

[Layer Configuration of Coating-Type Antireflection Film]

An antireflection film having on its substrate a layer construction comprising at least an intermediate-refractive-index layer, a high-refractive-index layer and a low-refractive-index layer (outermost layer) in this order is designed to have a refractive index satisfying the following relationship.

The refractive index of the high-refractive-index layer>the refractive index of the intermediate-refractive-index layer>the refractive index of the transparent substrate>the refractive index of the low-refractive-index layer, and a hard coat layer may be provided between the transparent substrate and the intermediate-refractive-index layer.

The antireflection film may also be made up of an intermediate-refractive-index hard coat layer, a high-refractive-index layer and a low-refractive-index layer.

Examples of such antireflection films include: those described in Japanese Patent Application Laid-Open Nos. 8-122504, 8-110401, 10-300902, 2002-243906 and 2000-111706. Other functions may also be imparted to each layer. There are proposed, for example, antireflection films that include a stainproof low-refractive-index layer or anti-static high-refractive-index layer (e.g. Japanese Patent Application Laid-Open Nos. 10-206603 and 2002-243906).

The haze of the antireflection film is preferably 5% or less and more preferably 3% or less. The strength of the film is preferably H or higher, by pencil hardness test in accordance with JIS K5400, more preferably 2H or higher, and most preferably 3H or higher.

[High-Refractive-Index Layer and Intermediate-Refractive-Index Layer]

The layer of the antireflection film having a high refractive index comprises a curable film that contains: at least ultra-fine particles of high-refractive-index inorganic compound having an average particle size of 100 nm or less; and a matrix binder.

Fine particles of high-refractive-index inorganic compound include: for example, those of inorganic compounds having a refractive index of 1.65 or more and preferably 1.9 or more. Specific examples of such inorganic compounds include: oxides of Ti, Zn, Sb, Sn, Zr, Ce, Ta, La or In; and composite oxides containing these metal atoms.

Methods of forming such ultra-fine particles include: for example, treating the particle surface with a surface treatment agent (e.g. a silane coupling agent, Japanese Patent Application Laid-Open Nos. 11-295503, 11-153703, 2000-9908, an anionic compound or organic metal coupling agent, Japanese Patent Application Laid-Open No. 2001-310432 etc.); allowing particles to have a core-shell structure in which a core is made up of high-refractive-index particle(s) (Japanese Patent Application Laid-Open No. 2001-166104 etc.); and using a specific dispersant in combination (Japanese Patent Application Laid-Open No. 11-153703, U.S. Pat. No. 6,210,858B1, Japanese Patent Application Laid-Open No. 2002-2776069, etc.).

Materials used for forming a matrix include: for example, conventionally known thermoplastic resins and curable resin films.

Further, as such a material, at least one composition is preferable which is selected from the group consisting of: a composition including a polyfunctional compound that has at least two radically polymerizable and/or cationically polymerizable group; an organic metal compound containing a hydrolytic group; and a composition as a partially condensed product of the above organic metal compound. Examples of such materials include: compounds described in Japanese Patent Application Laid-Open Nos. 2000-47004, 2001-315242, 2001-31871 and 2001-296401.

A curable film prepared using a colloidal metal oxide obtained from the hydrolyzed condensate of metal alkoxide and a metal alkoxide composition is also preferred. Examples are described in Japanese Patent Application Laid-Open No. 2001-293818.

The refractive index of the high-refractive-index layer is generally 1.70 to 2.20. The thickness of the high-refractive-index layer is preferably 5 nm to 10 μm and more preferably 10 nm to 1 μm.

The refractive index of the intermediate-refractive-index layer is adjusted to a value between the refractive index of the low-refractive-index layer and that of the high-refractive-index layer. The refractive index of the intermediate-refractive-index layer is preferably 1.50 to 1.70.

[Low-Refractive-Index Layer]

The low-refractive-index layer is formed on the high-refractive-index layer sequentially in the laminated manner. The refractive index of the low-refractive-index layer is 1.20 to 1.55 and preferably 1.30 to 1.50.

Preferably, the low-refractive-index layer is formed as the outermost layer having scratch resistance and stainproofing properties. As means of significantly improving scratch resistance, it is effective to provide the surface of the layer with slip properties, and conventionally known thin film forming means introducing silicone or fluorine can be applied.

The refractive index of the fluorine-containing compound is preferably 1.35 to 1.50 and more preferably 1.36 to 1.47. The fluorine-containing compound is preferably a compound that includes a crosslinkable or polymerizable functional group containing fluorine atom in an amount of 35 to 80% by mass.

Examples of such compounds include: compounds described in Japanese Patent Application Laid-Open No. 9-222503, columns [0018] to [0026], Japanese Patent Application Laid-Open No. 11-38202, columns [0019] to [0030], Japanese Patent Application Laid-Open No. 2001-40284, columns [0027] to [0028], Japanese Patent Application Laid-Open No. 2000-284102, etc.

A silicone compound is preferably such that it has a polysiloxane structure, it includes a curable or polymerizable functional group in its polymer chain, and it has a crosslinking structure in the film. Examples of such silicone compounds include: reactive silicone (e.g. SILAPLANE manufactured by Chisso Corporation); and polysiloxane having a silanol group on each of its ends (one described in Japanese Patent Application Laid-Open No. 11-258403).

The crosslinking or polymerization reaction for preparing such fluorine-containing polymer and/or siloxane polymer containing a crosslinkable or polymerizable group is preferably carried out by radiation of light or by heating simultaneously with or after applying a coating composition for forming an outermost layer, which contains a polymerization initiator, a sensitizing agent, etc.

A sol-gel cured film is also preferable which is obtained by curing the above coating composition by the condensation reaction carried out between an organic metal compound, such as silane coupling agent, and silane coupling agent containing a specific fluorine-containing hydrocarbon group in the presence of a catalyst.

Examples of such films include: those of polyfluoroalkyl-group-containing silane compounds or the partially hydrolyzed and condensed compounds thereof (compounds described in Japanese Patent Application Laid-Open Nos. 58-142958, 58-147483, 58-147484, 9-157582 and 11-106704); and silyl compounds that contain a poly “perfluoroalkyl ether” group as a fluorine-containing long-chain group (compounds described in Japanese Patent Application Laid-Open Nos. 2000-117902, 2001-48590 and 2002-53804).

The low-refractive-index layer can contain additives other than the above described ones, such as a filler (e.g. low-refractive-index inorganic compounds whose primary particles have an average particle size of 1 to 150 nm, such as silicon dioxide (silica) and fluorine-containing particles (magnesium fluoride, calcium fluoride, barium fluoride); organic fine particles described in Japanese Patent Application Laid-Open No. 11-3820, columns [0020] to [0038]), a silane coupling agent, a slippering agent, a surfactant and the like.

When located as the outermost layer, the low-refractive-index layer may be formed by a vapor phase method (vacuum evaporation, spattering, ion plating, plasma CVD, etc.). From the viewpoint of reducing producing costs, a coating method is preferable.

The thickness of the low-refractive-index layer is preferably 30 to 200 nm, more preferably 50 to 150 nm, and most preferably 60 to 120 nm.

[Hard Coat Layer]

A hard coat layer is provided on the surface of both stretched and unstretched cellulose acylate films so as to impart physical strength to the antireflection film. Particularly preferably the hard coat layer is provided between the stretched cellulose acylate film and the above described high-refractive-index layer and between the unstretched cellulose acylate film and the above described high-refractive-index layer. It is also preferable to provide the hard coat layer directly on the stretched and unstretched cellulose acylate films by coating without providing an antireflection layer.

Preferably, the hard coat layer is formed by the crosslinking reaction or polymerization of compounds curable by light and/or heat. Preferred curable functional groups are photopolymerizable functional groups, and organic metal compounds having a hydrolytic functional group are preferably organic alkoxy silyl compounds.

Specific examples of such compounds include the same compounds as illustrated in the description of the high-refractive-index layer.

Specific examples of compositions that constitute the hard coat layer include: those described in Japanese Patent Application Laid-Open Nos. 2002-144913, 2000-9908 and WO 00/46617.

The high-refractive-index layer can also serve as a hard coat layer. In this case, it is preferable to form the hard coat layer using the technique described in the description of the high-refractive-index layer so that fine particles are contained in the hard coat layer in the dispersed state.

The hard coat layer can also serves as an anti-glare layer (described later), if particles having an average particle size of 0.2 to 10 μm are added to provide the layer with the anti-glare function.

The thickness of the hard coat layer can be properly designed depending on the applications for which it is used. The thickness of the hard coat layer is preferably 0.2 to 10 μm and more preferably 0.5 to 7 μm.

The strength of the hard coat layer is preferably H or higher, by pencil hardness test in accordance with JIS K5400, more preferably 2H or higher, and much more preferably 3H or higher. The hard coat layer having a smaller abrasion loss in test, before and after Taber abrasion test conducted in accordance with JIS K5400, is more preferable.

[Forward Scattering Layer]

A forward scattering layer is provided so that it provides, when applied to liquid crystal displays, the effect of improving viewing angle when the angle of vision is tilted up-, down-, right- or leftward. The above described hard coat layer can also serve as a forward scattering layer, if fine particles with different refractive index are dispersed in it.

Example of such layers include: those described in Japanese Patent Application Laid-Open No. 11-38208 where the coefficient of forward scattering is specified; those described in Japanese Patent Application Laid-Open No. 2000-199809 where the relative refractive index of transparent resin and fine particles are allowed to fall in the specified range; and those described in Japanese Patent Application Laid-Open No. 2002-107512 wherein the haze value is specified to 40% or higher.

[Other Layers]

Besides the above described layers, a primer layer, anti-static layer, undercoat layer or protective layer may be provided.

[Coating Method]

The layers of the antireflection film can be formed by any method of dip coating, air knife coating, curtain coating, roller coating, wire bar coating, gravure coating, microgravure coating and extrusion coating (U.S. Pat. No. 2,681,294).

[Anti-Glare Function]

The antireflection film may have the anti-glare function that scatters external light. The anti-glare function can be obtained by forming irregularities on the surface of the antireflection film. When the antireflection film has the anti-glare function, the haze of the antireflection film is preferably 3 to 30%, more preferably 5 to 20%, and most preferably 7 to 20%.

As a method for forming irregularities on the surface of antireflection film, any method can be employed, as long as it can maintain the surface geometry of the film. Such methods include: for example, a method in which fine particles are used in the low-refractive-index layer to form irregularities on the surface of the film (e.g. Japanese Patent Application Laid-Open No. 2000-271878); a method in which a small amount (0.1 to 50% by mass) of particles having a relatively large size (0.05 to 2 μm in particle size) are added to the layer under a low-refractive-index layer (high-refractive-index layer, intermediate-refractive-index layer or hard coat layer) to form a film having irregularities on the surface and a low-refractive-index layer is formed on the irregular surface while keeping the geometry (e.g. Japanese Patent Application Laid-Open Nos. 2000-281410, 2000-95893, 2001-100004, 2001-281407); a method in which irregularities are physically transferred on the surface of the outermost layer (stainproof layer) having been provided (e.g. embossing described in Japanese Patent Application Laid-Open Nos. 63-278839, 11-183710, 2000-275401).

[Applications]

The unstretched and stretched cellulose acylate films of the present invention are useful as optical films, particularly as polarizing plate protective film, optical compensation sheet (also referred to as retardation film) for liquid crystal displays, optical compensation sheet for reflection-type liquid crystal displays, and substrate for silver halide photographic photosensitive materials.

In the following the measurement methods used in the present invention will be described.

(1) Wet-Heat Change of Dimension (δL(w))

1) A sample film is cut out along the MD and TD directions, and undergoes moisture conditioning at 25° C., 60% rh for 5 hours or more, and then the lengths of the sample film are measured with a pin gauge having a base length of 20 cm (the lengths obtained are represented by MD(F) and TD(F), respectively).

2) The sample film thus prepared is allowed to stand for 500 hours in a constant-temperature, constant-humidity chamber set at 60° C., 90% rh without any tension applied to the sample film (thermo treatment).

3) After the sample film is taken out from the constant-temperature, constant-humidity chamber, the sample film undergoes moisture conditioning at 25° C., 60% rh for 5 hours or more and then the lengths of the sample film are measured with the pin gauge having a base length of 20 cm (the lengths obtained are represented by MD(t) and TD(t), respectively).

4) By using the following formulas, the wet-heat changes of dimension (δMD(w), δTD(w)) along the MD and TD directions are derived; the larger value of these changes is defined as the wet-heat change of dimension (δL(w)).
δTD(w)(%)=100×|TD(F)−TD(t)|/TD(F)
δMD(w)(%)=100×|MD(F)−MD(t)|/MD(F)

(2) Dry-Heat Change of Dimension (δL(d))

The dry-heat change of dimension is derived in the same manner as in the derivation of the above-described wet-heat change of dimension except that the thermo treatment is changed to a dry treatment at 80° C. for 500 hours.

(3) Re, Rth

A sample film undergoes moisture conditioning at 25° C., 60% rh for 5 hours or more. Then, the retardation values at a wavelength of 550 nm are measured by using an automatic double refraction meter (KOBRA-21ADH: manufactured by Ouji Science Instrument) at 25° C., 60% rh while allowing light to enter the film along the direction normal to the film surface and along the direction inclined by ±40° from the normal to the film surface. And the in-plane retardation (Re) is calculated from the normal direction measurement value, and the thicknesswise direction retardation (Rth) is calculated from the normal direction and +40° direction measurement values. These values are defined as Re and Rth, respectively.

(4) Wet-Heat Changes of Re and Rth

1) A sample film undergoes moisture conditioning at 25° C., 60% rh for 5 hours or more, and then the Re and Rth of the sample film are measured according to the above-described method (the values obtained are represented by Re(f) and Rth(f), respectively).

2) The sample film thus prepared is allowed to stand for 500 hours in a constant-temperature, constant-humidity chamber set at 60° C., 90% rh without any tension applied to the sample film (thermo treatment).

3) After the sample film is taken out from the constant-temperature, constant-humidity chamber, the sample film undergoes moisture conditioning at 25° C., 60% rh for 5 hours or more, and then the Re and Rth of the sample film are measured according to the above-described method (the values obtained are represented by Re(t) and Rth(t), respectively).

4) By using the following formulas, the wet-heat changes of the Re and Rth are derived.
Wet-heat change of Re (%)=100×(Re(f)−Re(t))/Re(f)
Wet-heat change of Rth (%)=100×(Rth(f)−Rth(t))/Rth(f)

(5) Dry-Heat Changes of Re and Rth

The dry-heat changes of Re and Rth are derived in the same manner as in the derivation of the above-described wet-heat changes of Re and Rth except that the thermo treatment is changed to a dry treatment at 80° C. for 500 hours.

(6) Fine Retardation Unevenness

A sample film undergoes moisture conditioning at 25° C., 60% rh for 5 hours or more, and then the Re values of the sample film are measured by using an ellipsometer (an automatic double-refraction measurement apparatus, ABR-10A-10AT, manufactured by UNIOPT Co., Ltd.) at 10 points while the measurement location is being shifted by 0.1 mm along the MD direction. The difference between the maximum and the minimum of these 10 measured values is divided by the average value over these 10 measured values to yield a value (the fine retardation unevenness of MD). Along the TD direction, a measurement is made in the same manner as along the MD direction while the measurement location is being shifted by 0.1 mm, to yield a value (the fine retardation unevenness of TD).

The larger value of the fine retardation unevenness of MD and the fine retardation unevenness of TD is defined as the fine retardation unevenness.

(7) Longitudinal-to-Transverse Ratio

The longitudinal-to-transverse ratio is a value (L/W) obtained by dividing the separation (L: the distance between the centers of the two pairs of niprolls) between the niprolls used in stretching by the width (W) of the not-yet stretched cellulose acylate film. When three or more pairs of niprolls are used, the largest L/W value is defined as the longitudinal-to-transverse ratio.

(8) Relaxation Ratio

The relaxation ratio means a value obtained by dividing the relaxation length by the length before stretching and by representing in terms of percent.

(9) Substitution Degree of Cellulose Acylate

The substitution degree of the acyl groups of cellulose acylate are obtained by the method described in Carbohydr. Res. 273 (1995) 83-91 (Tedzuka et al.), using 13C-NMR.

In the following the features of the present invention will be described in further detail by examples and comparative examples. It is to be understood that various changes in the materials used, the amount, proportion and treatment of the same, the treatment procedure for the same, etc. may be made without departing from the spirit of the present invention. Accordingly, it is also to be understood that the scope of the present invention is not limited to the following examples.

### EXAMPLES

### (1) Formation of Cellulose Acylate Film

In each of Examples 1 to 5 and Comparative Examples 1 and 2, a cellulose resin (CAP-482-20; number average molecular weight: 70000; glass transition temperature (Tg): 140° C.) was extruded to a die with a single-screw extruder (manufactured by Toshiba Machine Co., Ltd.; screw diameter: φ90 mm; L/D: 30; screw compression ratio: 3.2) at an extrusion temperature of 220° C. or higher, and the molten resin was discharged from the die at the discharge temperature described in Table 1 onto a cooling drum and a line speed of 10 m/min to form a 100 μm thick film.

### (2) Evaluation of the Melt-Formed Film

### Unstretched

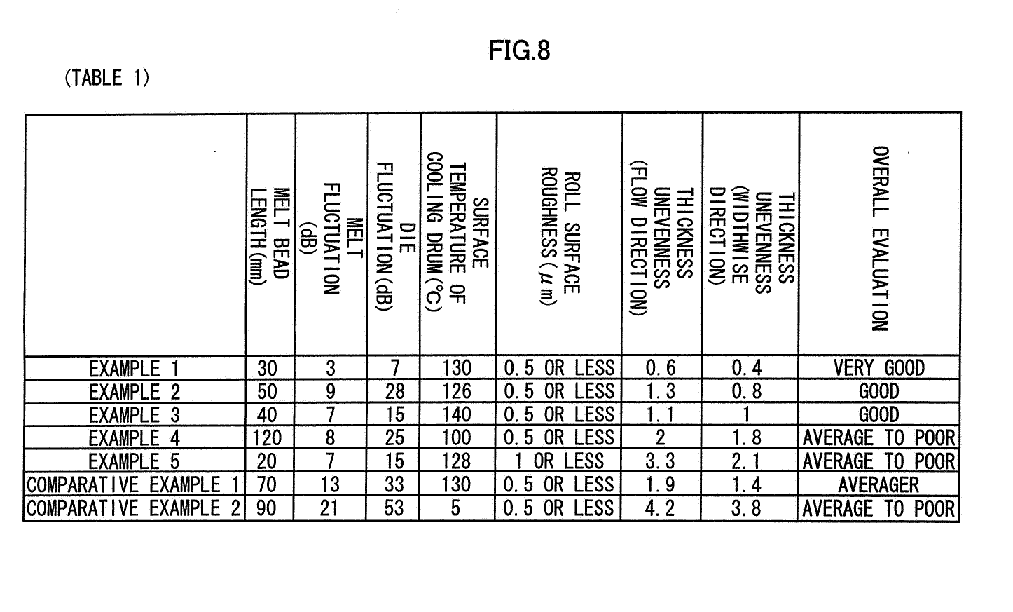

Each of the cellulose resin films obtained as described above was subjected to the measurements of the length (melt bead length) of the sheet-shaped molten resin 12 from the discharge opening of the die 24 to the landing point on the cooling drum 28, the fluctuation (dB) of the sheet-shaped molten resin 12 in the vicinity of the surface of the cooling drum 28, the fluctuation (dB) of the die 24, the surface temperature (° C.) of the cooling drum 28, and the surface roughness (Ra) of the cooling drum 28. The results thus obtained are shown in Table 1 of FIG. 8.

In the measurement of the melt bead length, a displacement meter (CCD, LS-7000) manufactured by Keyence Corporation was used, and the maximum value of the 1-minute measurement was defined as the measured value. The measured values each were rounded off to the nearest whole number.

In the measurement of the fluctuation (dB) of a sheet-shaped molten resin 12 and the fluctuation (dB) of the die 24, a vibrometer (Digital display vibrometer, Model-1332A) manufactured by Showa Sokki Corporation was used, and the maximum value of the 1-minute measurement was defined as the measured value. It is to be noted that the decibel (dB) is a dimensionless unit that expresses logarithmically the ratio of one value to a reference value. Specifically, the decibel value of B in relation to a reference value A is represented by 10·log₁₀(B/A). In other words, 10 dB means a power (ratio) of 10, 3 dB means a power (ratio) of 1.995 (approximately 2), −3 dB means a power (ratio) of 0.5. Incidentally, 0 dB means a power (ratio) of 1, 1.995 dB means a power (ratio) of 2, 4.77 dB means a power (ratio) of 3, 3.981 dB means a power (ratio) of 4, 6.99 dB means a power (ratio) of 5, and 7.943 dB means a power (ratio) of 8.

The measurement of the surface roughness (Ra) was carried out by using a three-dimensional surface roughness meter manufactured by Tokyo Seimitsu Co., Ltd. under the conditions of a measurement length of 50 mm and a cut-off length of 0.8 mm.

Additionally, the evaluation of the thickness unevenness generated in a film was carried out with a continuous thickness meter manufactured by Yamabun Electric Co., Ltd. by measuring the thickness of the central portion of the film with a measurement length of 3 m and a measurement pitch interval of 0.5 mm.

As can be seen from Table 1 of FIG. 8, the thickness unevenness generated in the film along the flow direction and the thickness unevenness generated in the film along the widthwise direction exhibited small values and thus a cellulose resin film comprehensively excellent in surface quality so as to be free from thickness unevenness was obtained in any of Examples 1 to 3 each of which satisfied the requirements that the length of the sheet-shaped molten resin 12 from the discharge opening of the die 24 to the landing point on the cooling drum 28 be 10 mm or more and 100 mm or less, the fluctuation (dB) of the sheet-shaped molten resin 12 in the vicinity of the surface of the cooling drum 28 be 10 dB or less, the fluctuation (dB) of the die 24 be 30 dB or less, the surface temperature (° C.) of the cooling drum 28 be Tg−20° C. to Tg+20° C., and the surface roughness (Ra) of the cooling drum 28 be 0.5 μm or less.

On the other hand, as can be seen, in Example 4 in which the melt bead length value was 120 mm to fall outside the range from 10 mm to 100 mm, there was able to be obtained only a film inferior in surface quality to the cellulose resin films obtained in Examples 1 to 3.

Additionally, as can be seen, in Example 5 in which the surface roughness value of the roll was 1 μm to fall outside the range of 0.5 μm or less, there was able to be obtained only a film inferior in surface quality to the cellulose resin films obtained in Examples 1 to 3.

### (3) Preparation of Polarizing Plate

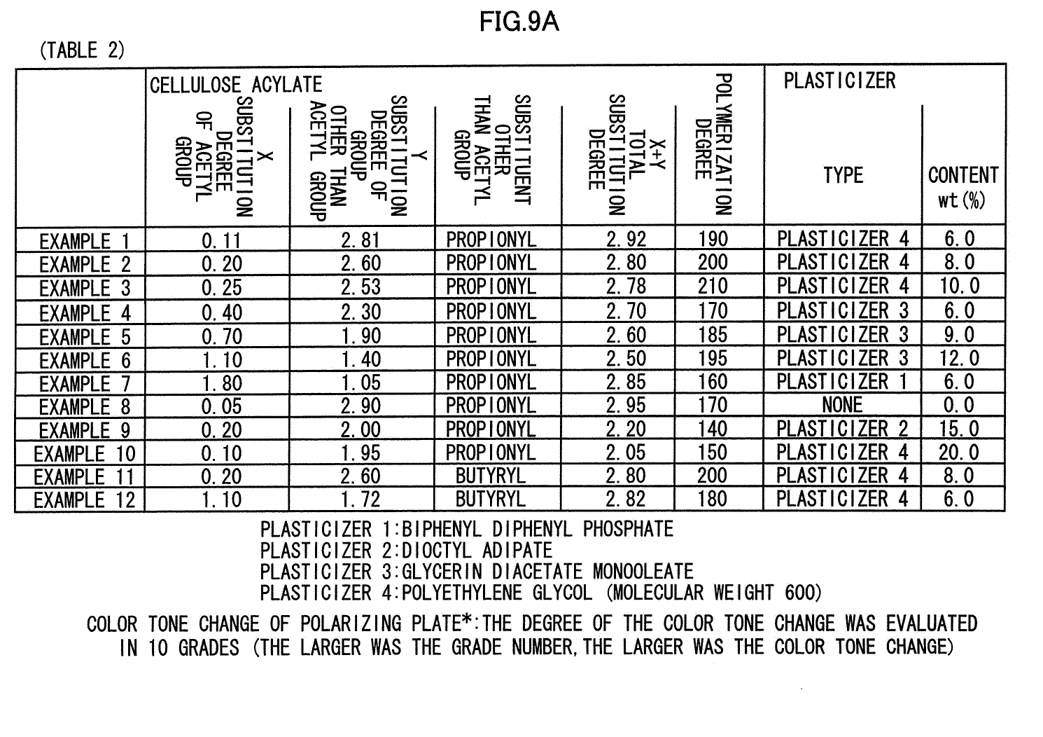

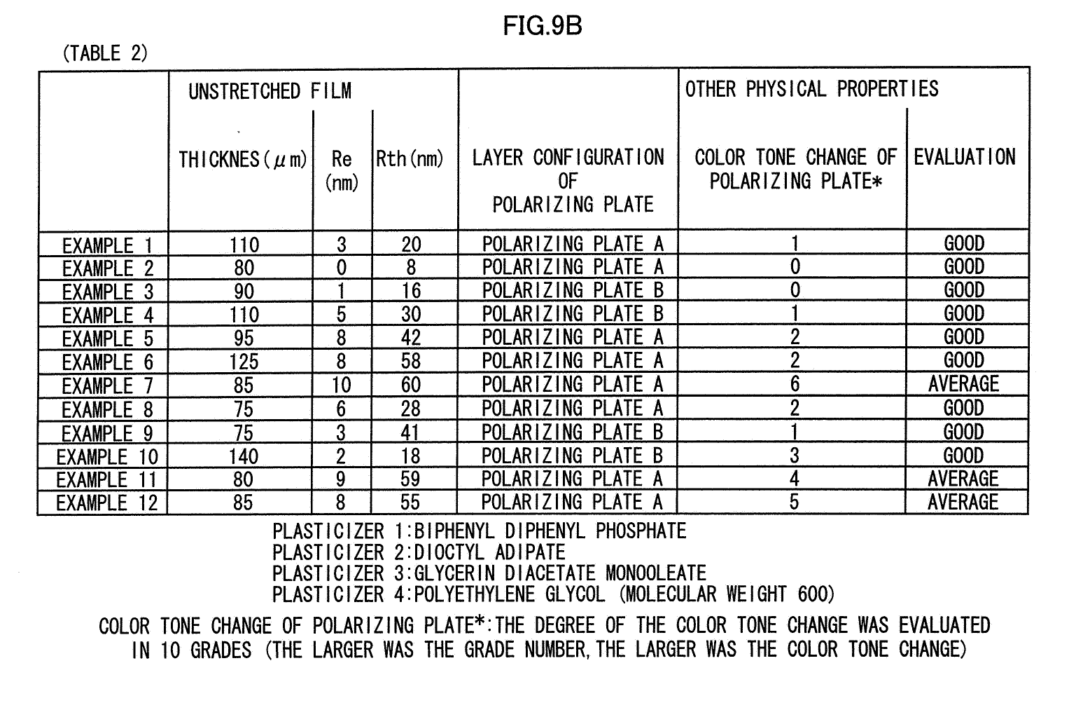

Under the film formation conditions of Example 1 in Table 1 of FIG. 8, unstretched films different in the film materials (different in the substitution degree, the polymerization degree, and the type and amount of the plasticizer) as shown in Table 2 of FIGS. 9A and 9B were produced, and the following polarizing plates were prepared.

(3-1) Saponification of Cellulose Acylate Film

Each unstretched cellulose acylate film was saponified by the immersion-saponification process described below. Almost the same results were obtained for the unstretched cellulose acylate films saponified by the following coating-saponification process.

(i) Coating-Saponification Process

To 80 parts by mass of isopropanol, 20 parts by mass of water was added, and KOH was dissolved in the above mixture so that the normality of the solution was 2.5. The temperature of the solution was adjusted to 60° C. and used as a saponifying solution. The saponifying solution was applied to the cellulose acylate film at 60° C. in an amount of 10 g/m² to allow the cellulose acylate film to undergo saponification for 1 minute. Then, the saponified cellulose acylate film underwent spray washing with warm water spray at 50° C. at a spraying rate of 10 L/m².min for 1 minute.

(ii) Immersion-Saponification Process

As a saponifying solution, 2.5 N NaOH aqueous solution was used. The temperature of this solution was adjusted to 60° C., and each cellulose acylate film was immersed in the solution for 2 minutes. Then, the film was immersed in 0.1 N aqueous solution of sulfuric acid for 30 seconds and passed through a water washing bath.

(3-2) Preparation of Polarizing Layer

A polarizing layer 20 μm thick was prepared by creating a difference in peripheral velocity between two pairs of nip rolls to carry out stretching in the longitudinal direction in accordance with Example 1 described in Japanese Patent Application Laid-Open No. 2001-141926.

(3-3) Lamination

The polarizing layer thus obtained, the above described saponified unstretched and stretched cellulose acylate films, and saponified Fujitack (unstretched triacetate film) were laminated with a 3% PVA aqueous solution (PVA-117H, manufactured by Kuraray Co., Ltd.) as an adhesive, in the direction of the polarizing film stretching and the cellulose acylate film forming flow (longitudinal direction) in the following combinations.

Polarizing plate A: unstretched cellulose acylate film/polarizing layer/Fujitack

Polarizing plate B: unstretched cellulose acylate film/polarizing layer/unstretched cellulose acylate film

(3-4) Color Tone Change of Polarizing Plate

The magnitude of the color tone change of the sheets of polarizing plate thus obtained was graded according to 10 ranks (the larger number indicates the larger color tone change). The sheets of polarizing plate prepared by embodying the present invention both gained high grades.

(3-5) Evaluation of Humidity Curl

The sheets of polarizing plate thus obtained were evaluated by the above described method. The cellulose acylate film formed by embodying the present invention showed good characteristics (low humidity curl).

Sheets of polarizing plate were also prepared in which lamination was performed so that the polarization axis and the longitudinal direction of the cellulose acylate film were crossed at right angles and at an angle of 45°. The same evaluation was made for them. The results were the same as those of the sheets of polarizing plate in which the polarizing film and the cellulose acylate film were laminated in parallel with each other.

### (4) Preparation of Optical Compensation Film and Liquid Crystal Display Device

The polarizing plate provided on the observers' side in a 22-inch LCD device (manufactured by Sharp Corporation) in which VA-mode LC cell was used was stripped off. Instead of the polarizing plate, the above described retardation polarizing plate A or B was laminated on the observers' side in the above LCD device via an adhesive so that the cellulose acylate film is on the side of the LC cell. A liquid crystal display device was prepared by arranging the polarizing plate so that the transmission axis of the polarizing plate on the observers' side and that of the polarizing plate on the backlight side were crossed at right angles.

In this case, too, the cellulose acylate film of the present invention exhibits a low humidity curl, and therefore, it was easy to laminate, whereby it was less likely to be out of position when laminated.

Further, when using the cellulose acylate film of the present invention, instead of the cellulose acetate film of Example 1 described in Japanese Patent Application Laid-Open No. 11-316378 whose surface was coated with a liquid crystal layer, a good optical compensation film exhibiting a low humidity curl could be obtained.

When using the cellulose acylate film of the present invention, instead of the cellulose acetate film of Example 1 described in Japanese Patent Application Laid-Open No. 7-333433 whose surface was coated with a liquid crystal layer, a good optical compensation film exhibiting a low humidity curl could be obtained.

Further, when using the polarizing plate and retardation polarizing plate of the present invention in the liquid crystal display described in Example 1 of Japanese Patent Application Laid-Open No. 10-48420, for the optically anisotropic layer containing discotic liquid crystal molecules, for the orientation film whose surface was coated with polyvinyl alcohol, in the 20-inch VA-mode liquid crystal display described in FIGS. 2 to 9 of Japanese Patent Application Laid-Open No. 2000-154261, in the 20-inch OCB-mode liquid crystal display described in FIGS. 10 to 15 of Japanese Patent Application Laid-Open No. 2000-154261, and in the IPS-mode liquid crystal display described in FIG. 11 of Japanese Patent Application Laid-Open No. 2004-12731, good liquid crystal displays devices exhibiting a low humidity curl were obtained.

### (5) Preparation of Low Reflection Film

A low reflection film was prepared in accordance with Example 47 described in Journal of Technical Disclosure (Laid-Open No. 2001-1745) issued by Japan Institute of Invention and Innovation. The humidity curl of the prepared film was measured by the above described method. The cellulose acylate film formed by embodying the present invention produced good results when formed into a low reflection film, just like the case where it is formed into sheets of polarizing plate.

The low reflection film of the present invention was laminated on the outermost surface of the liquid crystal display described in Example 1 of Japanese Patent Application Laid-Open No. 10-48420, the 20-inch VA-mode liquid crystal display described in FIGS. 2 to 9 of Japanese Patent Application Laid-Open No. 2000-154261, the 20-inch OCB-mode liquid crystal display described in FIGS. 10 to 15 of Japanese Patent Application Laid-Open No. 2000-154261, and the IPS-mode liquid crystal display described in FIG. 11 of Japanese Patent Application Laid-Open No. 2004-12731 and the resultant liquid crystal displays were evaluated. The liquid crystal displays obtained were all good.

What is claimed is:

1. A method for producing a cellulose resin film based on a melt film formation method comprising the steps of:
discharging a molten resin melted with an extruder from a discharge opening of a die as a sheet-shaped molten resin onto a traveling or rotating cooling support to be solidified by cooling;
thereafter stripping off the sheet as a cellulose resin film; and
winding up the cellulose resin film on a wind-up spool;
wherein the fluctuation of the sheet-shaped molten resin in the vicinity of the surface of the cooling support is 10 dB or less.

2. The method for producing a cellulose resin film according to claim 1, wherein the length of the sheet-shaped molten resin between the discharge opening of the die and the landing position on the cooling support is 10 mm to 100 mm.

3. The method for producing a cellulose resin film according to claim 1, wherein the fluctuation of the die is 30 dB or less.

4. The method for producing a cellulose resin film according to claim 1, wherein the surface temperature of the cooling support is Tg−20° C. to Tg+20° C.

5. The method for producing a cellulose resin film according to claim 1, wherein the surface roughness of the surface of the cooling support is 0.5 μm or less.

6. The method for producing a cellulose resin film according to claim 1, wherein the surface of the cooling support is plated with hard chrome.

7. The method for producing a cellulose resin film according to claim 1, further comprising a step of pushing the sheet-shaped molten resin landing on the cooling support against the cooling support by blowing air to the sheet-shaped molten resin from an air knife unit.

8. The method for producing a cellulose resin film according to claim 1, further comprising a step of applying static electricity to the sheet-shaped molten resin discharged from the die with a static electricity application unit.

9. The method for producing a cellulose resin film according to claim 1, further comprising a step of applying a reduced pressure to a side, upstream of the rotation or traveling direction of the cooling support, of the sheet-shaped molten resin discharged from the die with a pressure reduction chamber.

10. The method for producing a cellulose resin film according to claim 1, further comprising a step of edge-pinning both of the edges of the sheet-shaped molten resin discharged from the die by applying charge from edge pinning electrodes to both of the edges.

11. The method for producing a cellulose resin film according to claim 1, further comprising a step of imparting a knurling of 5 to 20 mm in width and 5 μm to 30 μm in height to each of the both edges of the cellulose resin film in advance of the winding-up step.

12. The method for producing a cellulose resin film according to claim 11, further comprising a step of heating the knurling-imparted portions of the cellulose resin film at Tg+10° C. to Tg+50° C.

13. The method for producing a cellulose resin film according to claim 1, wherein the thickness unevenness per 1 m along the lengthwise direction in the cellulose resin film is within ±2% and the thickness unevenness per the total width along the widthwise direction in the cellulose resin film is within ±2%.

14. The method for producing a cellulose resin film according to claim 1, wherein the cellulose resin film is a film for use in optical applications.

15. A cellulose resin film for use in optical applications produced by the method for producing a cellulose resin film according to claim 1.
